(19) United States
(12) Patent Application Publication
(10) Pub. No.: US 2019/0306534 A1
(43) Pub. Date: Oct. 3, 2019

(54) UNIFICATION OF DEBLOCKING FILTER AND ADAPTIVE LOOP FILTER

(71) Applicant: QUALCOMM Incorporated, San Diego, CA (US)

(72) Inventors: Li Zhang, San Diego, CA (US); Wei-Jung Chien, San Diego, CA (US); Jie Dong, Sunnyvale, CA (US); Kai Zhang, San Diego, CA (US); Marta Karczewicz, San Diego, CA (US)

(21) Appl. No.: 16/371,605

(22) Filed: Apr. 1, 2019

Related U.S. Application Data
(60) Provisional application No. 62/651,640, filed on Apr. 2, 2018.

(51) Int. Cl. H04N 19/86; H04N 19/132; H04N 19/82; H04N 19/70

(52) U.S. Cl. CPC H04N 19/86; H04N 19/70; H04N 19/82; H04N 19/132

(57) ABSTRACT

A video encoder or video decoder may be configured to obtain a block of decoded video data, wherein the block of video data comprises a set of samples; apply a first filter operation to a first subset of the set of samples to generate a first subset of filtered samples; apply a second filter operation to a second subset of the set of samples to generate a second subset of filtered samples, wherein the first subset is different than the second subset; and output a block of filtered samples comprising the first subset of filtered samples and the second subset of filtered samples.

This application claims the benefit of U.S. Provisional Patent Application 62/651,640, filed Apr. 2, 2018, the entire content of which is hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the recently finalized High Efficiency Video Coding (HEVC) standard, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques associated with filtering reconstructed video data in a video encoding and/or video decoding processes and, more particularly, this disclosure describes techniques related to deblocking filtering and adaptive loop filtering (ALF).

According to one example, a method for decoding video data includes obtaining a block of reconstructed video data, wherein the block of video data comprises a set of samples; applying a first filter operation to a first subset of the set of samples to generate a first subset of filtered samples; applying a second filter operation to a second subset of the set of samples to generate a second subset of filtered samples, wherein the first subset is different than the second subset; and outputting a block of filtered samples comprising the first subset of filtered samples and the second subset of filtered samples.

According to another example, a device for decoding video data includes a memory configured to store video data and one or more processors coupled to the memory, implemented in circuitry, and configured to: obtain a block of reconstructed video data, wherein the block of video data comprises a set of samples; apply a first filter operation to a first subset of the set of samples to generate a first subset of filtered samples; apply a second filter operation to a second subset of the set of samples to generate a second subset of filtered samples, wherein the first subset is different than the second subset; and output a block of filtered samples comprising the first subset of filtered samples and the second subset of filtered samples.

According to another example, a computer-readable storage medium stores instructions that when executed by one or more processors cause the one or more processors to obtain a block of reconstructed video data, wherein the block of video data comprises a set of samples; apply a first filter operation to a first subset of the set of samples to generate a first subset of filtered samples; apply a second filter operation to a second subset of the set of samples to generate a second subset of filtered samples, wherein the first subset is different than the second subset; and output a block of filtered samples comprising the first subset of filtered samples and the second subset of filtered samples.

According to another example, an apparatus includes means for obtaining a block of reconstructed video data, wherein the block of video data comprises a set of samples; means for applying a first filter operation to a first subset of the set of samples to generate a first subset of filtered samples; means for applying a second filter operation to a second subset of the set of samples to generate a second subset of filtered samples, wherein the first subset is different than the second subset; and means for outputting a block of filtered samples comprising the first subset of filtered samples and the second subset of filtered samples.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating a mapping of ranges for an activity metric and a direction metric to filters.

FIGS. 3A-3C show examples of filter shapes.

FIG. 4 shows an example of class index denoted by Ci based on matrix results (activity value Act and directionality D).

FIG. 5 shows an example of a 5×5 diamond-shaped filter support.

FIG. 6 shows examples of geometry transformations.

FIG. 7 is a flow diagram showing an example of an overall process for performing de-block filtering.

FIG. 8 is a flow diagram showing a process for calculating a boundary strength.

FIG. 9 shows an example of pixels involved in filter on/off decision and strong/weak filter selection.

FIG. 10 shows an example of filtering stages that may be used to filter a reconstructed block.

FIG. 11 shows an example of filtering stages that may be used to filter a reconstructed block.

FIGS. 12A and 12B shows an example of settings of samples which may be filtered by DF and ALF.

FIGS. 13-16 show examples of unified DB and ALF solutions.

FIG. 17 is a block diagram illustrating an example video encoder that may implement the techniques described in this disclosure.

FIG. 18 is a block diagram illustrating an example video decoder that may implement the techniques described in this disclosure.

FIG. 19 is a flowchart showing an example of a video decoding process.

### DETAILED DESCRIPTION

Video coding typically involves predicting a block of video data from either an already coded block of video data in the same picture (i.e. intra prediction) or an already coded block of video data in a different picture (i.e. inter prediction). In some instances, the video encoder also calculates residual data by comparing the predictive block to the original block. Thus, the residual data represents a difference between the predictive block and the original block. The video encoder transforms and quantizes the residual data and signals the transformed and quantized residual data in the encoded bitstream. A video decoder adds the residual data to the predictive block to produce a reconstructed video block that matches the original video block more closely than the predictive block alone. To further improve the quality of decoded video, a video decoder can perform one or more filtering operations on the reconstructed video blocks. Examples of these filtering operations include deblocking filtering, sample adaptive offset (SAO) filtering, and adaptive loop filtering (ALF). Parameters for these filtering operations may either be determined by a video encoder and explicitly signaled in the encoded video bitstream or may be implicitly determined by a video decoder without needing the parameters to be explicitly signaled in the encoded video bitstream.

This disclosure describes techniques associated with filtering reconstructed video data in a video encoding and/or video decoding processes and, more particularly, this disclosure describes techniques related to deblocking filtering and ALF. The described techniques, however, may also be applied to other filtering schemes, such as other types of loop filtering, such as those that utilize explicit signaling of filter parameters. In accordance with this disclosure, filtering is applied at an encoder, and filter information is encoded in the bitstream to enable a decoder to identify the filtering that was applied at the encoder. The video encoder may test several different filtering scenarios, and based on, for example, a rate-distortion analysis, choose a filter or set of filters that produces a desired tradeoff between reconstructed video quality and compression quality. The video decoder either receives encoded video data that includes the filter information or implicitly derives the filter information, decodes the video data, and applies filtering based on the filtering information. In this way, the video decoder applies the same filtering that was applied at the video encoder.

This disclosure describes techniques related to unification of deblocking filter and ALF. Deblocking filter and ALF tend to perform filtering for different purposes, but in the techniques described in this disclosure, the deblocking filter and ALF may be unified. The techniques may reduce the filter stages in a video codec and may be used in the context of advanced video codecs, such as extensions of HEVC or the next generation of video coding standards.

As used in this disclosure, the term video coding generically refers to either video encoding or video decoding. Similarly, the term video coder may generically refer to a video encoder or a video decoder. Moreover, certain techniques described in this disclosure with respect to video decoding may also apply to video encoding, and vice versa. For example, often times video encoders and video decoders are configured to perform the same process, or reciprocal processes. Also, video encoder typically perform video decoding as part of the processes of determining how to encode video data.

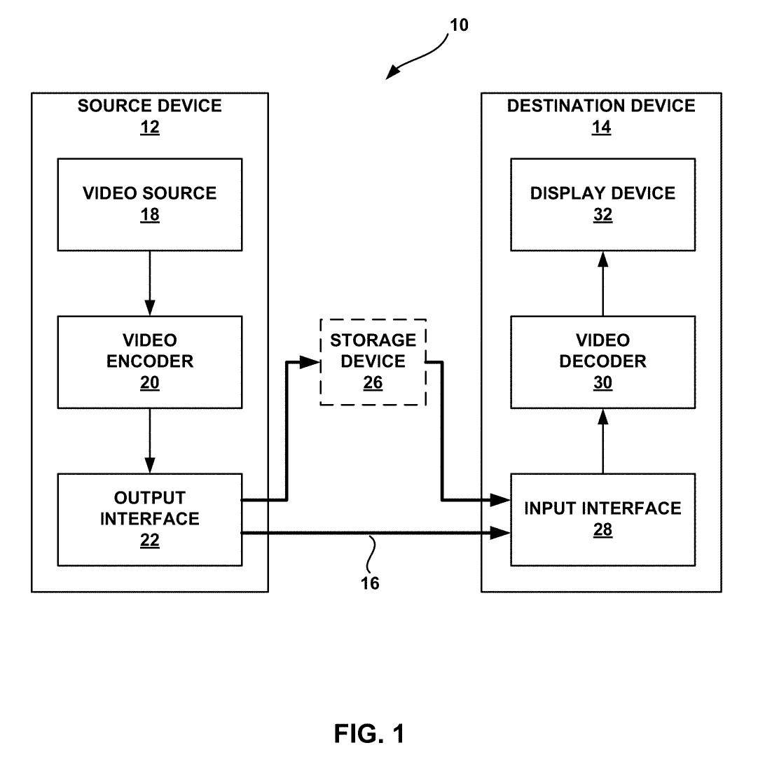

FIG. 1 is a block diagram illustrating an example video encoding and decoding system 10 that may utilize the filtering techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 26. Similarly, encoded data may be accessed from storage device 26 by input interface. Storage device 26 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 26 may correspond to a file server or another intermediate storage device that may hold the encoded video generated by source device 12. Destination device 14 may access stored video data from storage device 26 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 26 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 26 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 26, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the recently finalized High Efficiency Video Coding (HEVC) standard, and may conform to the HEVC Test Model (HM). Alternatively, video encoder 20 and video decoder 30 may operate according to other proprietary or industry standards, such as the ITU-T H.264 standard, alternatively referred to as ISO/IEC MPEG-4, Part 10, Advanced Video Coding (AVC), or extensions of such standards, such as the Scalable Video Coding (SVC) and Multi-view Video Coding (MVC) extensions. The techniques of this disclosure, however, are not limited to any particular coding standard. Other examples of video compression standards include ITU-T H.261, ISO/IEC MPEG-1 Visual, ITU-T H.262 or ISO/IEC MPEG-2 Visual, ITU-T H.263, and ISO/IEC MPEG-4 Visual.

ITU-T VCEG (Q6/16) and ISO/IEC MPEG (JTC 1/SC 29/WG 11) are now studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate proposed compression technology designs. The JVET first met during 19-21 Oct. 2015 and developed several different versions of reference software, referred to as Joint Exploration Models (JEM). One example of such reference software is referred to as JEM 7 and is described in J. Chen, E. Alshina, G. J. Sullivan, J.-R. Ohm, J. Boyce, “Algorithm Description of Joint Exploration Test Model 7,” JVET-G1001, 13-21 Jul. 2017.

Based on the work of ITU-T VCEG (Q6/16) and ISO/IEC MPEG (JTC 1/SC 29/WG 11), a new video coding standard, referred to as the Versatile Video Coding (VVC) standard, is under development by the Joint Video Expert Team (WET) of VCEG and MPEG. An early draft of the VVC is available in the document JVET-J1001 “Versatile Video Coding (Draft 1)” and its algorithm description is available in the document WET-J1002 “Algorithm description for Versatile Video Coding and Test Model 1 (VTM 1).” Another early draft of the VVC is available in the document JVET-L1001 “Versatile Video Coding (Draft 3)” and its algorithm description is available in the document JVET-L1002 “Algorithm description for Versatile Video Coding and Test Model 3 (VTM 3).”

Techniques of this disclosure may utilize HEVC terminology for ease of explanation. It should not be assumed, however, that the techniques of this disclosure are limited to HEVC, and in fact, it is explicitly contemplated that the techniques of this disclosure may be implemented in successor standards to HEVC and its extensions.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In HEVC and other video coding specifications, a video sequence typically includes a series of pictures. Pictures may also be referred to as “frames.” In one example approach, a picture may include three sample arrays, denoted S_{L}, S_{Cb}, and S_{Cr}. In such an example approach, S_{L} is a two-dimensional array (i.e., a block) of luma samples. So is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may comprise a coding tree block of luma samples, two corresponding coding tree blocks of chroma samples, and syntax structures used to code the samples of the coding tree blocks. In monochrome pictures or pictures having three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

To generate a coded CTU, video encoder 20 may recursively perform quad-tree partitioning on the coding tree blocks of a CTU to divide the coding tree blocks into coding blocks, hence the name “coding tree units.” A coding block may be an N×N block of samples. A CU may comprise a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may comprise a single coding block and syntax structures used to code the samples of the coding block.

Video encoder 20 may partition a coding block of a CU into one or more prediction blocks. A prediction block is a rectangular (i.e., square or non-square) block of samples on which the same prediction is applied. A prediction unit (PU) of a CU may comprise a prediction block of luma samples, two corresponding prediction blocks of chroma samples, and syntax structures used to predict the prediction blocks. In monochrome pictures or pictures having three separate color planes, a PU may comprise a single prediction block and syntax structures used to predict the prediction block. Video encoder 20 may generate predictive luma, Cb, and Cr blocks for luma, Cb, and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU. If video encoder 20 uses inter prediction to generate the predictive blocks of a PU, video encoder 20 may generate the predictive blocks of the PU based on decoded samples of one or more pictures other than the picture associated with the PU.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb, and Cr residual blocks of a CU into one or more luma, Cb, and Cr transform blocks. A transform block is a rectangular (e.g., square or non-square) block of samples on which the same transform is applied. A transform unit (TU) of a CU may comprise a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients.

Video encoder 20 may output a bitstream that includes a sequence of bits that forms a representation of coded pictures and associated data. The bitstream may comprise a sequence of Network Abstraction Layer (NAL) units. A NAL unit is a syntax structure containing an indication of the type of data in the NAL unit and bytes containing that data in the form of a raw byte sequence payload (RBSP) interspersed as necessary with emulation prevention bits. Each of the NAL units includes a NAL unit header and encapsulates a RBSP. The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a PPS, a second type of NAL unit may encapsulate an RBSP for a coded slice, a third type of NAL unit may encapsulate an RBSP for SEI messages, and so on. NAL units that encapsulate RBSPs for video coding data (as opposed to RBSPs for parameter sets and SEI messages) may be referred to as VCL NAL units.

Video decoder 30 may receive a bitstream generated by video encoder 20. In addition, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 20. In addition, video decoder 30 may inverse quantize coefficient blocks associated with TUs of a current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

In the field of video coding, it is common to apply filtering in order to enhance the quality of a decoded video signal. The filter can be applied as a post-filter, where the filtered frame is not used for prediction of future frames or as an in-loop filter, where the filtered frame is used to predict future frames. A filter can be designed, for example, by minimizing the error between the original signal and the decoded filtered signal. Similarly, to transform coefficients the coefficients of the filter h(k,l), k=−K, . . . , K, l=−K, . . . K may be quantized according to the following formula,

f(k,l)=round(normFactor·h(k,l)),

coded, and sent to the decoder. The normFactor may, for example, be set equal to 2ⁿ. A larger the value of normFactor typically leads to a more precise quantization, and the quantized filter coefficients f(k,l) typically provide better performance However, larger values of normFactor also typically produce coefficients f(k,l) that require more bits to transmit.

At video decoder 30, the decoded filter coefficients f(k,l) are applied to the reconstructed image R(i,j) as follows

$$\tilde{R} ( i , j ) = {\sum }_{k = - K}^{K} {\sum }_{l = - K}^{K} f ( k , l ) R ( i + k , j + l ) / {\sum }_{k = - k}^{K} {\sum }_{l = - K}^{K} f ( k , l ) , \qquad ( 1 )$$

where i and j are the coordinates of the pixels within the frame.

The in-loop adaptive loop filter employed in JEM was originally proposed in J. Chen, Y. Chen, M. Karczewicz, X. Li, H. Liu, L. Zhang, X. Zhao, “Coding tools investigation for next generation video coding”, SG16-Geneva-C806, January 2015, the description of which is incorporated herein by reference. ALF was proposed in HEVC, and was included in various working drafts and test model software, i.e., the HEVC Test Model (or “HM”), although ALF was not included in the final version of HEVC. Among the related technologies, the ALF design in the HEVC test model version HM-3.0 was claimed as the most efficient design. (See T. Wiegand, B. Bross, W. J. Han, J. R. Ohm and G. J. Sullivan, “WD3: Working Draft 3 of High-Efficiency Video Coding,” Joint Collaborative Team on Video Coding (JCT-VC) of ITU-T SG16 WP3 and ISO/IEC JTC1/SC29/WG11, JCTVC-E603, 5th Meeting: Geneva, CH, 16-23 Mar. 2011, hereinafter “Working Draft 3”, the entire contents of which are incorporated herein by reference). Therefore, the ALF design from HM-3.0 is introduced herein.

The version of ALF included in HM-3.0 is based on picture level optimization. That is, the ALF coefficients are derived after a whole frame is coded. There were two modes for the luma component, referred to as block based adaptation (BA) and region based adaptation (RA). These two modes share the same filter shapes, filtering operations, as well as the same syntax elements. One difference between BA and RA is the classification method, where classification generally refers to classifying a pixel or block of pixels so as to determine which filter from a set of filters to apply to the pixel or block of pixels.

In one example approach, the classification in BA is at a block level. For the luma component, 4×4 blocks in the whole picture are classified based on one-dimensional (1D) Laplacian direction (e.g., up to 3 directions) and two-dimensional (2D) Laplacian activity (e.g., up to 5 activity values). In one example approach, each 4×4 block in a picture is assigned a group index based on one-dimensional (1D) Laplacian direction and two-dimensional (2D) Laplacian activity. One example calculation of direction Dir_{b} and unquantized activity Act_{b} is shown in equations (2)-(5) below, where Î_{i,j} indicates a reconstructed pixel with relative coordinate (i,j) to the top-left pixel position of a 4×4 block, V_{i,j} and H_{i,j} are the absolute values of vertical and horizontal gradient of the pixel located at (i,j). As such, direction Dir_{b} is generated by comparing the absolute values of the vertical gradient and the horizontal gradient in the 4×4 block and Act_{b} is the sum of the gradients in both directions in the 4×4 block. Act_{b} is further quantized to the range of 0 to 4, inclusive, as described in the “WD3: Working Draft 3 of High-Efficiency Video Coding” document discussed above.

$$\begin{matrix}{V}_{i , j} = \vert {\hat{I}}_{i , j} \times 2 - {\hat{I}}_{i , j - 1} - {\hat{I}}_{i , j + 1} \vert & ( 2 ) \\ {H}_{i , j} = \vert {\hat{I}}_{i , j} \times 2 - {\hat{I}}_{i - 1 , j} - {\hat{I}}_{i + 1 , j} \vert & ( 3 ) \\ {Dir}_{b} = \{ \begin{matrix}1 , if ( {\sum }_{i = 0}^{3} {\sum }_{j = 0}^{3} {H}_{i , j} > 2 \times {\sum }_{i = 0}^{3} {\sum }_{j = 0}^{3} {V}_{i , j} ) \\ 2 , if ( {\sum }_{i = 0}^{3} {\sum }_{j = 0}^{3} {V}_{i , j} > 2 \times {\sum }_{i = 0}^{3} {\sum }_{j = 0}^{3} {H}_{i , j} ) \\ 0 , otherwise\end{matrix} & ( 4 ) \\ {Act}_{b} = {\sum }_{i = 0}^{3} {\sum }_{j = 0}^{3} ( {\sum }_{m = i - 1}^{i + 1} {\sum }_{n = j - 1}^{j + 1} ( {V}_{m , n} + {H}_{m , n} ) ) & ( 5 )\end{matrix}$$

In one example approach, each block can be categorized into one out of fifteen (5×3) groups (i.e., classes) as follows. An index is assigned to each 4×4 block according to the value of Dir_{b} and Act_{b} of the block. Denote the group index by C and set C equal to 5Dir_{b}+Â where Â is the quantized value of Act_{b}. Therefore, up to fifteen sets of ALF parameters may be signaled for the luma component of a picture. To save the signaling cost, the groups may be merged along group index value. For each merged group, a set of ALF coefficients is signaled.

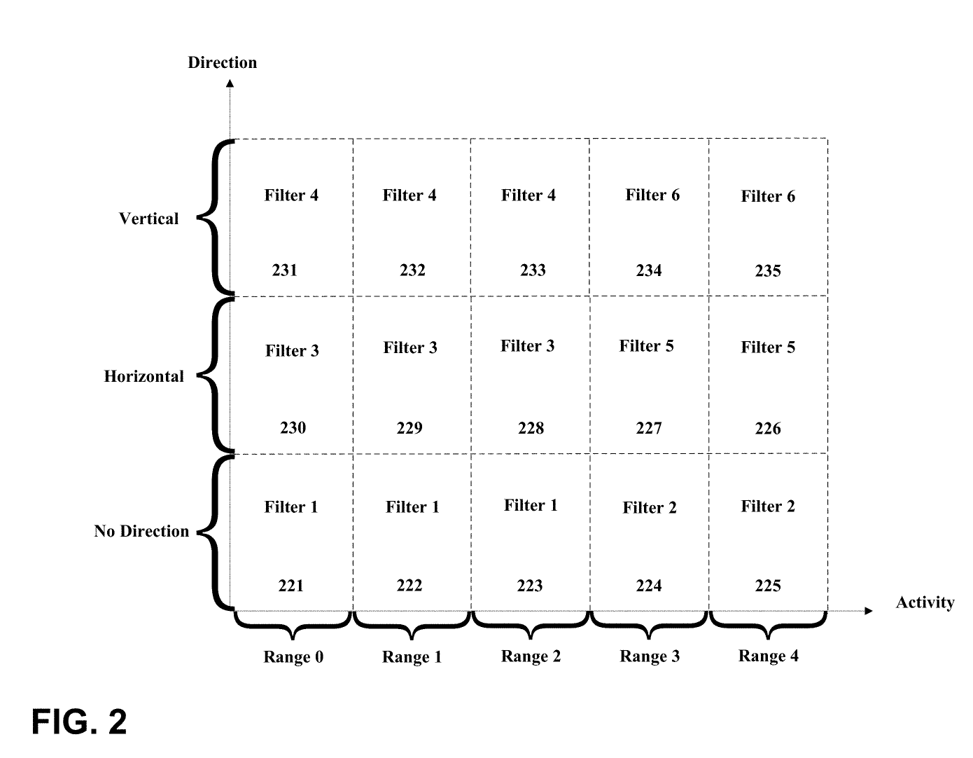

FIG. 2 is a conceptual diagram illustrating these 15 groups (also referred to as classes) used for BA classification. In the example of FIG. 2, filters are mapped to ranges of values for an activity metric (i.e., Range 0 to Range 4) and a direction metric. The direction metric in FIG. 2 is shown as having values of No Direction, Horizontal, and Vertical, which may correspond to the values of 0, 1, and 2 above from equation 4. The particular example of FIG. 2 shows six different filters (i.e. Filter 1, Filter 2 . . . Filter 6) as being mapped to the 15 categories, but more or fewer filters may similarly be used. Although FIG. 2 shows an example, with 15 groups, identified as groups 221 through 235, more or fewer groups may also be used. For example, instead of five ranges for the activity metric more or fewer ranges may be used resulting in more groups. Additionally, instead of only three directions, additional or alternative directions (e.g. a 45-degree direction and 135-degree direction) may also be used.

As will be explained in greater detail below, the filters associated with each group of blocks may be signaled using one or more merge flags. For one-dimensional group merging, a single flag may be sent to indicate if a group is mapped to the same filter as a previous group. For two-dimensional merging, a first flag may be sent to indicate if a group is mapped to the same filter as a first neighboring block (e.g. one of a horizontal or vertical neighbor), and if that flag is false, a second flag may be sent to indicate if the group is mapped to a second neighboring block (e.g. the other of the horizontal neighbor or the vertical neighbor).

Classes may be grouped into what are called merged groups, where each class in the merged group maps to the same filter. Referring to FIG. 2 as an example, groups 221, 222, and 223 may be grouped into a first merged group; groups 224 and 225 may be grouped into a second merged group, and so on. Typically, not all classes mapped to a certain filter need to be in the same merged group, but all classes in the merged group need to be mapped to the same filter. In other words, two merged groups may map to the same filter.

Filter coefficients may be defined or selected in order to promote desirable levels of video block filtering that can reduce blockiness and/or otherwise improve the video quality in other ways. A set of filter coefficients, for example, may define how filtering is applied along edges of video blocks or other locations within video blocks. Different filter coefficients may cause different levels of filtering with respect to different pixels of the video blocks. Filtering, for example, may smooth or sharpen differences in intensity of adjacent pixel values in order to help eliminate unwanted artifacts.

In this disclosure, the term “filter” generally refers to a set of filter coefficients. For example, a 3×3 filter may be defined by a set of 9 filter coefficients, a 5×5 filter may be defined by a set of 25 filter coefficients, a 9×5 filter may be defined by a set of 45 filter coefficients, and so on. The term “set of filters” generally refers to a group of more than one filter. For example, a set of two 3×3 filters, could include a first set of 9 filter coefficients and a second set of 9 filter coefficients. The term “shape,” sometimes called the “filter support,” generally refers to the number of rows of filter coefficients and number of columns of filter coefficients for a particular filter. For example, 9×9 is an example of a first shape, 7×7 is an example of a second shape, and 5×5 is an example of a third shape. In some instances, filters may take non-rectangular shapes including diamond-shapes, diamond-like shapes, circular shapes, circular-like shapes, hexagonal shapes, octagonal shapes, cross shapes, X-shapes, T-shapes, other geometric shapes, or numerous other shapes or configuration.

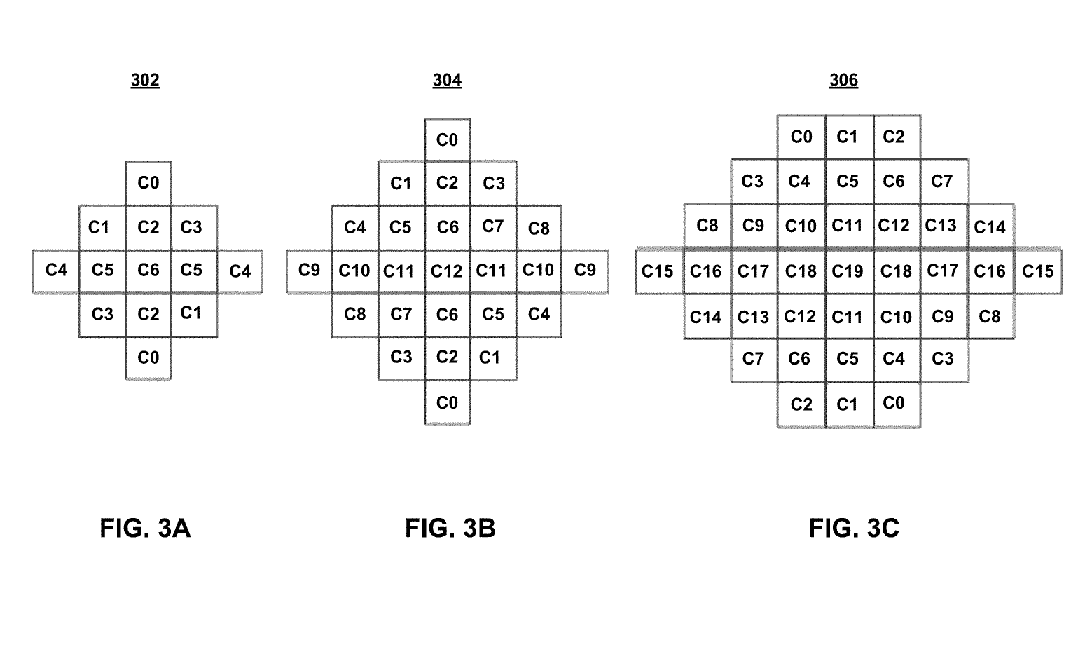

FIGS. 3A-3C show examples of three circular symmetric filter shapes. Specifically, FIG. 3A illustrates filter 302, which is in the shape of a 5×5 diamond. FIG. 3B illustrates filter 304, which is in the shape of a 7×7 diamond. FIG. 3C illustrates filter 305, which is in the shape of a truncated 9×9 diamond. The examples in FIGS. 3A-3C are diamond shapes, however, other shapes may be used. In most common cases, regardless of the shape of the filter, the center pixel in the filter mask is the pixel that is being filtered. In other examples, the filtered pixel may be offset from the center of the filter mask.

In one example approach, a single set of ALF coefficients may be applied to each of the chroma components in a picture. In one such approach, the 5×5 diamond shape filter may always be used. For both chroma components in a picture, a single set of ALF coefficients may be applied, and the 5×5 diamond shape filter may always used.

At decoder side, each pixel sample Î_{i,j} may be filtered, resulting in pixel value I′_{i,j} as shown in equation (6), where L denotes filter length, f_{m,n} represents filter coefficient and o indicates filter offset.

I′_{i,j}=(Σ_{m=-L}^{L}Σ_{n=-L}^{L}f_{m,n}×Î_{i+m,j+n}+o)>>(BD_{F}−1) (6)

wherein (1<<(BD_{F}−1))=Σ_{m=-L}^{L}Σ_{n=-L}^{L}f(m,n) and (o=(1<<(BD_{F}−2)).

In JEM2, the bit-depth, denoted by BD_{F} is set to 9, which means the filter coefficients may be in the range of [−256, 256].

Video encoder 20 and video decoder 30 may perform temporal prediction of filter coefficients. The ALF coefficients of previously coded pictures are stored and allowed to be reused as ALF coefficients of a current picture. The current picture may choose to use ALF coefficients stored for the reference pictures, and bypass the ALF coefficients signalling. In this case, only an index to one of the reference pictures is signalled, and the stored ALF coefficients of the indicated reference picture are simply inherited for the current picture. To indicate the usage of temporal prediction, one flag is firstly coded before sending the index.

Video encoder 20 and video decoder 30 may perform Geometry transformations-based ALF. In M. Karczewicz, L. Zhang, W.-J. Chien, X. Li, “EE2.5: Improvements on adaptive loop filter”, Exploration Team (JVET) of ITU-T SG 16 WP 3 and ISO/IEC JTC 1/SC 29/WG 11, Doc. JVET-B0060, 2nd Meeting: San Diego, USA, 20 Feb.-26 Feb. 2016 and M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-00038, 3rd Meeting: Geneva, CH, 26 May-1 Jun. 2016, the Geometric transformations-based ALF (GALF) is proposed and it has been adopted to the most recent version of JEM, i.e., JEM3.0. In GALF, the classification is modified with the diagonal gradients taken into consideration and geometric transformations may be applied to filter coefficients. Each 2×2 block is categorized into one out of 25 classes based on its directionality and quantized value of activity. The details are described in more detail below.

Video encoder 20 and video decoder 30 may select filters based on classifications. Similar to the design of the existing ALF, the classification is still based on the 1D Laplacian direction and 2D Laplacian activity of each N×N luma block. However, the definitions of both direction and activity have been modified to better capture local characteristics. Firstly, values of two diagonal gradients, in addition to the horizontal and vertical gradients used in the existing ALF, are calculated using 1-D Laplacian. As it can be seen from equations (7) to (10), the sum of gradients of all pixels within a 6×6 window that covers a target pixel is employed as the represented gradient of target pixel. According to experiments, the window size, i.e., 6×6, provides a good trade-off between complexity and coding performance. Each pixel is associated with four gradient values, with vertical gradient denoted by gᵥ, horizontal gradient denoted by gₕ, 135 degree diagonal gradient denoted by g_{d1} and 45 degree diagonal gradient denoted by g_{d2}.

$$\begin{matrix}{g}_{v} = {\sum }_{k = i - 2}^{i + 3} {\sum }_{i = j - 2}^{j + 3} {V}_{k , l} , \\ {V}_{k , l} = \vert 2 R ( k , l ) - R ( k , l - 1 ) - R ( k , l + 1 ) \vert & ( 7 ) \\ {g}_{h} = {\sum }_{k = i - 2}^{i + 3} {\sum }_{k = j - 2}^{j + 3} {H}_{k , l} , \\ {H}_{k , l} = \vert 2 R ( k , l ) - R ( k - 1 , l ) - R ( k + 1 , l ) \vert & ( 8 ) \\ {g}_{d 1} = {\sum }_{k = i - 2}^{i + 3} {\sum }_{l = j - 3}^{j + 3} D {1}_{k , l} , \\ D {1}_{k , l} = \vert 2 R ( k , l ) - R ( k - 1 , l - 1 ) - R ( k + 1 , l + 1 ) \vert & ( 9 ) \\ {g}_{d 2} = {\sum }_{k = i - 2}^{i + 3} {\sum }_{j = j - 2}^{j + 3} D {2}_{k , l} , \\ D {2}_{k , l} = \vert 2 R ( k , l ) - R ( k - 1 , l + 1 ) - R ( k + 1 , l - 1 ) \vert & ( 10 )\end{matrix}$$

Here, indices i and j refer to the coordinates of the upper left pixel in the 2×2 block.

TABLE 1
Values of Direction and Its Physical Meaning

| Direction values | physical meaning |
|---|---|
| 0 | Texture |
| 1 | Strong horizontal/vertical |
| 2 | horizontal/vertical |
| 3 | strong diagonal |
| 4 | diagonal |

To assign the directionality D, ratio of maximum and minimum of the horizontal and vertical gradients, denoted by R_{h,v} in equation (10) and the ratio of maximum and minimum of two diagonal gradients, denoted by R_{d1,d2} in equation (11) are compared against each other with two thresholds t₁ and t₂.

R_{h,v}=g_{h,v}^{max}/g_{h,v}^{min} (11)
wherein g_{h,v}^{max}=max(gₕ, gᵥ), g_{h,v}^{min}=min(gₕ, gᵥ),

R_{d0,d1}=g_{d0,d1}^{max}/g_{d0,d1}^{min} (12)
wherein g_{d0,d1}^{max}=max(g_{d0}, g_{d1}), g_{d0,d1}^{min}=min(g_{d0}, g_{d1})

By comparing the detected ratios of horizontal/vertical and diagonal gradients, five direction modes, i.e., D within the range of [0, 4] inclusive, are defined in equation (12). The values of D and its physical meaning are described in Table I.

$$D = \{ \begin{matrix}0 & {R}_{h , v} \leq {t}_{1} \&\& {R}_{d 0 , d 1} \leq {t}_{1} \\ 1 & {R}_{h , v} > {t}_{1} \&\& {R}_{h , v} > {R}_{d 0 , d 1} \&\& {R}_{h , v} > {t}_{2} \\ 2 & {R}_{h , v} > {t}_{1} \&\& {R}_{h , v} > {R}_{d 0 , d 1} \&\& {R}_{h , v} \leq {t}_{2} \\ 3 & {R}_{d 0 , d 1} > {t}_{1} \&\& {R}_{h , v} \leq {R}_{d 0 , d 1} \&\& {R}_{d 0 , d 1} > {t}_{2} \\ 4 & {R}_{d 0 , d 1} > {t}_{1} \&\& {R}_{h , v} \leq {R}_{d 0 , d 1} \&\& {R}_{d 0 , d 1} \leq {t}_{2}\end{matrix} . \qquad ( 13 )$$

The activity value Act is calculated as:

$$Act = {\sum }_{k = i - 2}^{i + 3} {\sum }_{l = j - 2}^{i + 3} ( {V}_{k , l} + {H}_{k , l} ) . \qquad ( 14 )$$

Act is further quantized to the range of 0 to 4 inclusive, and the quantized value is denoted as Â.

Video encoder 20 and video decoder 30 may perform a quantization process from activity value A to activity index Â. The quantization process is defined as follows:

avg_var=Clip_post(NUM_ENTRY−1,(Act*ScaleFactor)>>shift);

Â=ActivityToIndex[avg_var]

wherein NUM_ENTRY is set to 16, ScaleFactor is set to 24, shift is (3+internal coded-bitdepth), ActivityToIndex[NUM_ENTRY]={0, 1, 2, 2, 2, 2, 2, 3, 3, 3, 3, 3, 3, 3, 3, 4}, function Clip_post(a, b) returns the smaller value between a and b.

Due to different ways of calculating the activity value, the ScaleFactor and ActivityToIndex are both modified compared to the ALF design in JEM2.0. Therefore, in the proposed GALF scheme, each N×N block is categorized into one of 25 classes based on its directionality D and quantized value of activity Â:

C=5D+Â. (15)

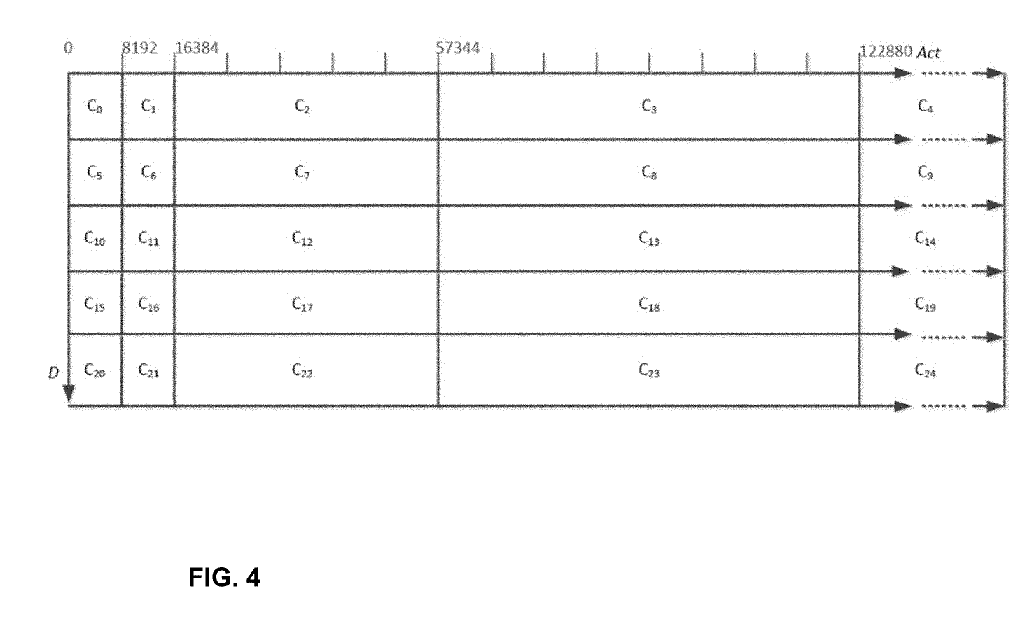

FIG. 4 shows an example of class index according to D and quantized value of activity Â. It should be noted that Â is set to 0 . . . 4 for each column which is derived from the variable Act. The smallest Act for a new value of Â is shown at the top (e.g., 0, 8192, 16384, etc.). For example, Act with values within [16384, 57344-1] will fall in Â equal to 2.

Video encoder 20 and video decoder 30 may perform geometry transformations. For each category, one set of filter coefficients may be signalled. To better distinguish different directions of blocks marked with the same category index, four geometry transformations, including no transformation, diagonal, vertical flip and rotation, are introduced.

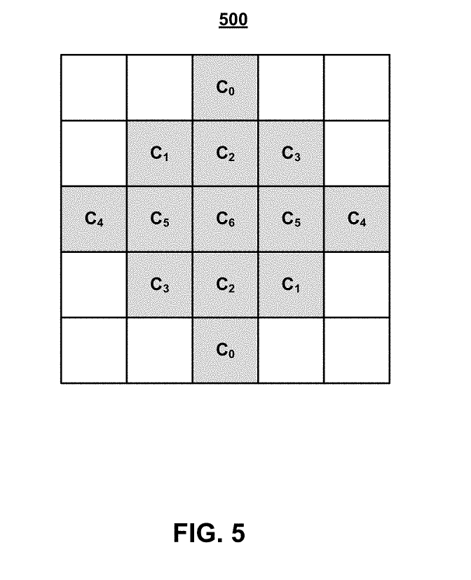

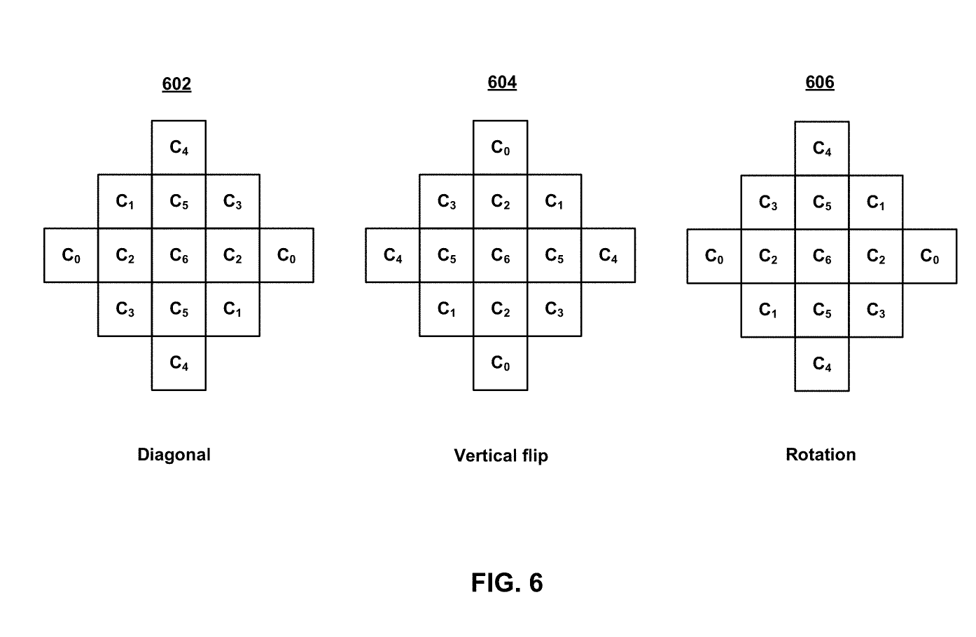

FIG. 5 shows an example of filter 500, which has a 5×5 diamond-shaped filter support. FIG. 6 shows an example of 5×5 filter support with the three geometric transformations. In FIG. 6, filter 602 represents the diagonal transformation of filter 500. Filter 604 represents the vertical flip transformation of filter 500, and filter 606 represents the rotation transformation of filter 500. Comparing FIG. 5 to FIG. 6, it can be seen that the formula forms of the three additional geometry transformations are as follows:

Diagonal: f_{D}(k,l)=f(l,k),

Vertical flip: fᵥ(k,l)=f(k,K−l−1),

Rotation: f_{R}(k,l)=f(K−l−1,k). (16)

where K is the size of the filter and 0≤k, l≤K−1 are coefficients coordinates, such that location (0,0) is at the upper left corner and location (K−1, K−1) is at the lower right corner. Note that when the diamond filter support is used, such as in the existing ALF, the coefficients with coordinate out of the filter support may be set to 0 (e.g., including will be always set to 0). One way of indicating the geometry transformation index is to derive it implicitly to avoid additional overhead. In GALF, the transformations are applied to the filter coefficients f(k,l) depending on gradient values calculated for that block. The relationship between the transformation and the four gradients calculated using (7)-(is described in Table 1. To summarize, the transformations is based on which one of two gradients (horizontal and vertical, or 45 degree and 135 degree gradients) is larger. Based on the comparison, more accurate direction information can be extracted. Therefore, different filtering results may be obtained due to transformation while the overhead of filter coefficients is not increased.

TABLE 2
MAPPING OF GRADIENT AND TRANSFORMATIONS.

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

Video encoder 20 and video decoder 30 may utilize filter supports. Similar to the ALF in HM, the GALF also adopts the 5×5 and 7×7 diamond filter supports. In addition, the original 9×7 filter support is replaced by the 9×9 diamond filter support.

Video encoder 20 and video decoder 30 may perform prediction from fixed filters. In addition, to improve coding efficiency when temporal prediction is not available (intra frames), a set of 16 fixed filters is assigned to each class. To indicate the usage of the fixed filter, a flag for each class is signaled and if required, the index of the chosen fixed filter. Even when the fixed filter is selected for a given class, the coefficients of the adaptive filter f(k,l) can still be sent for this class in which case the coefficients of the filter which will be applied to the reconstructed image are sum of both sets of coefficients. Number of classes can share the same coefficients f(k,l) signaled in the bitstream even if different fixed filters were chosen for them. U.S. Patent Publication 2017/0238020 A1 published 17 Aug. 2017 sets forth techniques for applying the fixed filters to inter-coded frames.

Video encoder 20 and video decoder 30 may perform signaling of filter coefficients. Prediction Pattern and Prediction index from fixed filters will now be discussed. Three cases are defined: case 1: whether none filters of the 25 classes are predicted from the fixed filter; case 2: all filters of the classes are predicted from the fixed filter; and case 3: filters associated with some classes are predicted from fixed filters and filters associated with the rest classes are not predicted from the fixed filters. An index may be firstly coded to indicate one of the three cases. In addition, the following applies:
If it is case 1, there is no need to further signal the index of fixed filter.
Otherwise, if it is case 2, an index of the selected fixed filter for each class is signaled
Otherwise (it is case 3), one bit for each class is firstly signaled, and if fixed filter is used, the index is further signaled.

Skipping of DC filter coefficient will now be discussed. Since the sum of all filter coefficients have to be equal to 2^{K} (wherein K denotes the bit-depth of filter coefficient), the DC filter coefficient which is applied to current pixel (center pixel within a filter support, such as C₆ in FIG. 3) may be derived without signaling.

Filter index will now be discussed. To reduce the number of bits required to represent the filter coefficients, different classes can be merged. However unlike in T. Wiegand, B. Bross, W.-J. Han, J.-R. Ohm and G. J. Sullivan, “WD3: Working Draft 3 of High-Efficiency Video Coding,” Joint Collaborative Team on Video Coding (JCT-VC) of ITU-T SG16 WP3 and ISO/IEC JTC1/SC29/WG11, JCTVC-E603, 5th Meeting: Geneva, CH, 16-23 Mar. 2011, any set of classes can be merged, even classes having non-consecutive values of C which denotes the class index as defined in (15). The information which classes are merged is provided by sending for each of the 25 classes an index i_{C}. Classes having the same index i_{C} share the same filter coefficients that are coded. The index i_{C} is coded with truncated binary binarization method. Other information, such as coefficients are coded in the same way as in JEM2.0

Video encoder 20 and video decoder 30 may perform deblock filtering. Deblocking filter in HEVC will now be discussed. In HEVC, after a slice is decoded and reconstructed, a Deblocking Filter (DF) process is performed for each CU in the same order as the decoding process. First, all vertical edges are filtered (horizontal filtering) then all horizontal edges are filtered (vertical filtering) based on the modified samples by horizontal filtering. Such a DF process is called 2-stage DF. Filtering is applied to 8×8 block boundaries which are determined to be filtered, both for luma and chroma components. 4×4 block boundaries are not processed in order to reduce the complexity.

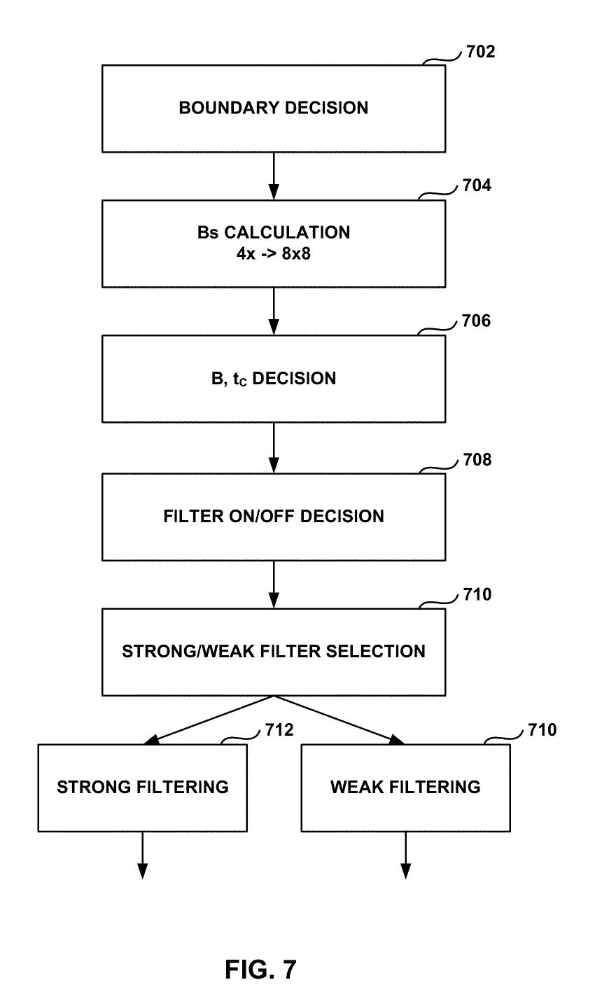

FIG. 7 shows the overall flow of a deblocking filter processes that may be performed by video encoder 20 or video decoder 30. A boundary can have three filtering status values: no filtering, weak filtering and strong filtering. Each filtering decision is based on boundary strength denoted by Bs, and threshold values, β and t_{C}.

Video encoder 20 and video decoder 30 may make boundary decisions (702). Two kinds of boundaries are involved in the deblocking filter process: TU boundaries and PU boundaries. CU boundaries are also considered, since CU boundaries are also TU and PU boundaries.

Video encoder 20 and video decoder 30 may perform boundary strength calculations (704). The boundary strength (Bs) reflects how strong a filtering process may be needed for the boundary. A value of 0 indicates no deblocking filtering. Let P and Q be defined as blocks which are involved in the filtering, where P represents the block located to the left (vertical edge case) or above (horizontal edge case) the boundary and Q represents the block located to the right (vertical edge case) or above (horizontal edge case) the boundary. Video encoder 20 and video decoder 30 determine values for β and t_{C} (706). Video encoder 20 and video decoder 30 make a filter on/off decision (708). Video encoder 20 and video decoder 30 make a strong/weak filter selection (710). Depending on the selection, video encoder 20 and video decoder 30 perform either weak filtering (710) or weak filtering (712).

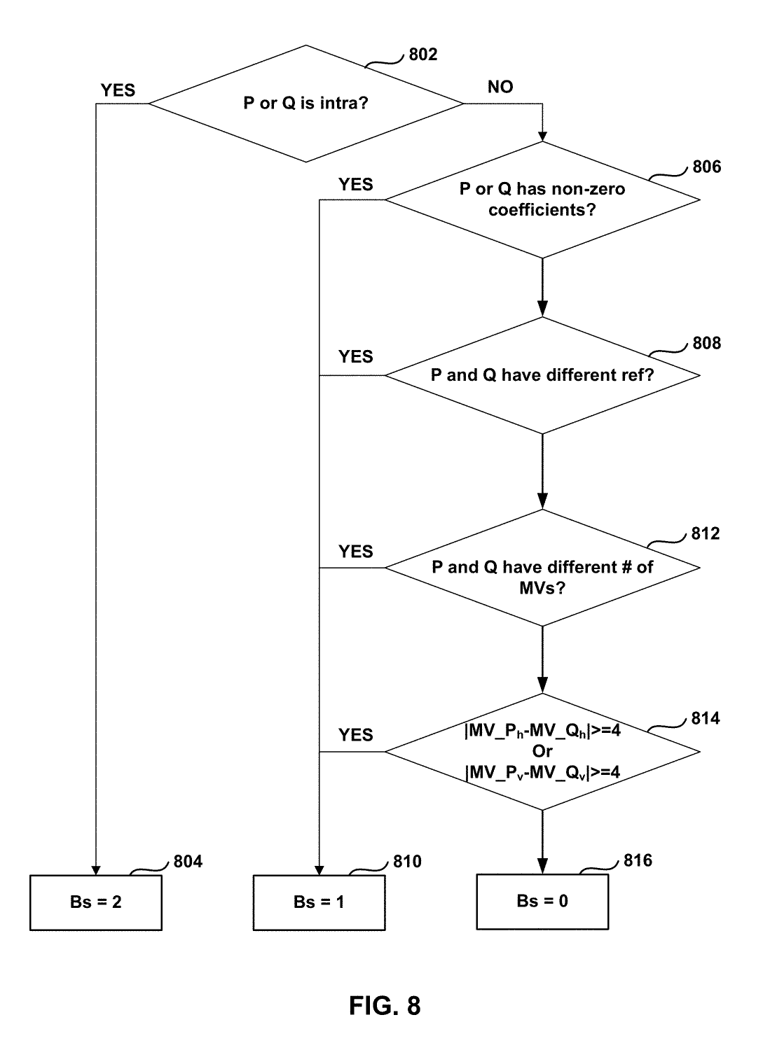

FIG. 8 is a flow diagram showing a process, that may be performed by video encoder 20 or video decoder 30, for calculating a boundary strength for a boundary between two blocks, i.e., block P and block Q in the example of FIG. 8. The boundary strength is calculated based on the intra coding mode, the existence of non-zero transform coefficients, reference picture, number of motion vectors, and motion vector difference. For blocks P and Q, video encoder 20 determines if either the P block or the Q blocks is encoded in an intra mode (802), and if one of the P block or the Q block is encoded in the intra mode (802, yes), then video encoder 20 sets the boundary strength equal to 2 (804). If both the P block and the Q block are not encoded in the intra mode (802, no), then video encoder 20 determines if either the P block or the Q block has any non-zero coefficients (806). If either the P block or the Q block has any non-zero coefficients (806, yes), then video encoder 20 sets the boundary strength equal to 1 (810).

If neither the P block nor the Q block have any non-zero coefficients (806, no), then video encoder 20 determines if the P block and the Q block have a different number of motion vectors (812). If the P block and the Q block have a different number of motion vectors (812, yes), then video encoder 20 sets the boundary strength equal to 1 (810). If the P block and the Q block do not have a different number of motion vectors (812, no), then video encoder 20 determines if a difference between horizontal components of the motion vectors or a difference between vertical components of the motion vectors for the Q block and the P block are greater than or equal to 4 (814). If the difference between the horizontal components of the motion vectors or a difference between the vertical components of the motion vectors for the Q block and the P block are greater than or equal to 4 (814, yes), then video encoder 20 sets the boundary strength equal to 1 (810). If the difference between the horizontal components of the motion vectors or a difference between the vertical components of the motion vectors for the Q block and the P block are less than 4 (814, no), then video encoder 20 sets the boundary strength equal to 0 (816).

Video encoder 20 and video decoder 30 may utilize threshold variables. Threshold values β and t_{C} are involved in the filter on/off decision, strong and weak filter selection and weak filtering process. These are derived from the value of the luma quantization parameter Q as shown in Table 1.

TABLE 1
Derivation of threshold variables from input Q

| | Q | | | | | | | | | | | | | | | | | | |
|---|---|---|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 | 16 | 17 | 18 |
| β′ | 0 | 0 | 0 | 0 | 0 | 0 | 0 | 0 | 0 | 0 | 0 | 0 | 0 | 0 | 0 | 0 | 6 | 7 | 8 |
| t_{c}′ | 0 | 0 | 0 | 0 | 0 | 0 | 0 | 0 | 0 | 0 | 0 | 0 | 0 | 0 | 0 | 0 | 0 | 0 | 1 |
| | Q | | | | | | | | | | | | | | | | | | |
| | 19 | 20 | 21 | 22 | 23 | 24 | 25 | 26 | 27 | 28 | 29 | 30 | 31 | 32 | 33 | 34 | 35 | 36 | 37 |
| β′ | 9 | 10 | 11 | 12 | 13 | 14 | 15 | 16 | 17 | 18 | 20 | 22 | 24 | 26 | 28 | 30 | 32 | 34 | 36 |
| t_{c}′ | 1 | 1 | 1 | 1 | 1 | 1 | 1 | 1 | 2 | 2 | 2 | 2 | 3 | 3 | 3 | 3 | 4 | 4 | 4 |

| | Q | | | | | | | | | | | | | | | |
|---|---|---|---|---|---|---|---|---|---|---|---|---|---|---|---|---|
| | 38 | 39 | 40 | 41 | 42 | 43 | 44 | 45 | 46 | 47 | 48 | 49 | 50 | 51 | 52 | 53 |
| β′ | 38 | 40 | 42 | 44 | 46 | 48 | 50 | 52 | 54 | 56 | 58 | 60 | 62 | 64 | — | — |
| t_{c}′ | 5 | 5 | 6 | 6 | 7 | 8 | 9 | 10 | 11 | 13 | 14 | 16 | 18 | 20 | 22 | 24 |

The variable β is derived from β′ as follows:

β=β′*(1<<(BitDepth_{Y}−8))

The variable t_{C} is derived from t_{C}′ as follows:

t_{C}=t_{C}′*(1<<(BitDepth_{Y}−8))

The deblocking parameters t_{C} and β provide adaptively according to the QP and prediction type. However, different sequences or parts of the same sequence may have different characteristics. It may be important for content providers to change the amount of deblocking filtering on the sequence or even on a slice or picture basis. Therefore, deblocking adjustment parameters can be sent in the slice header or picture parameters set (PPS) to control the amount of deblocking filtering applied. The corresponding parameters are tc-offset-div 2 and beta-offset-div 2, as described in JEM 7. These parameters specify the offsets (divided by two) that are added to the QP value before determining the β and t_{C} values. The parameter beta-offset-div 2 adjusts the number of pixels to which the deblocking filtering is applied, whereas parameter tc-offset-div 2 adjusts the amount of filtering that can be applied to those pixels, as well as detection of natural edges.

To be more specific, the following ways are used to re-calculate the ‘Q’ for the look-up tables:

For t_{C} calculation:

Q=Clip3(0,53,(QP+2*(Bs−1)+(tc-offset-div 2<<1)));

For β calculation:

Q=Clip3(0,53,(QP+(beta-offset-div 2<<1)));

In above equations, the QP indicates the derived value from the luma/chroma QPs of the two neighboring blocks along the boundary.

Syntax tables will now be discussed.

7.3.2.3.1 General Picture Parameter Set RBSP Syntax

| pic_parameter_set_rbsp( ) { | Descriptor |
|---|---|
| ... | |
| pps_loop_filter_across_slices_enabled_flag | u(1) |
| deblocking_filter_control_present_flag | u(1) |
| if( deblocking_filter_control_present_flag ) { | |
| deblocking_filter_override_enabled_flag | u(1) |
| pps_deblocking_filter_disabled_flag | u(1) |
| if( !pps_deblocking_filter_disabled_flag ) { | |
| pps_beta_offset_div2 | se(v) |
| pps_tc_offset_div2 | se(v) |
| } | |
| } | |
| ... | |
| } | |

7.3.6.1 General Slice Segment Header Syntax

| slice_segment_header( ) { | Descriptor |
|---|---|
| ... | |
| slice_qp_delta | se(v) |
| if( deblocking_filter_override_enabled_flag ) | |
| deblocking_filter_override_flag | u(1) |
| if( deblocking_filter_override_flag ) { | |
| slice_deblocking_filter_disabled_flag | u(1) |
| if( !slice_deblocking_filter_disabled_flag ) { | |
| slice_beta_offset_div2 | se(v) |
| slice_tc_offset_div2 | se(v) |
| } | |
| } | |
| if( pps_loop_filter_across_slices_enabled_flag && | |
| ( slice_sao_luma_flag \|\| slice_sao_chroma_flag \|\| | |
| !slice_deblocking_filter_disabled_flag ) ) | |
| slice_loop_filter_across_slices_enabled_flag | u(1) |
| } | |
| ... | |
| } | |

Semantics will now be described.

pps_deblocking_filter_disabled_flag equal to 1 specifies that the operation of deblocking filter is not applied for slices referring to the PPS in which slice_deblocking_filter_disabled_flag is not present. pps_deblocking_filter_disabled_flag equal to 0 specifies that the operation of the deblocking filter is applied for slices referring to the PPS in which slice_deblocking_filter_disabled_flag is not present. When not present, the value of pps_deblocking_filter_disabled_flag is inferred to be equal to 0.

pps_beta_offset_div 2 and pps_tc_offset_div 2 specify the default deblocking parameter offsets for β and tC (divided by 2) that are applied for slices referring to the PPS, unless the default deblocking parameter offsets are overridden by the deblocking parameter offsets present in the slice headers of the slices referring to the PPS. The values of pps_beta_offset_div 2 and pps_tc_offset_div 2 shall both be in the range of −6 to 6, inclusive. When not present, the value of pps_beta_offset_div 2 and pps_tc_offset_div 2 are inferred to be equal to 0.

pps_scaling_list_data_present_flag equal to 1 specifies that the scaling list data used for the pictures referring to the PPS are derived based on the scaling lists specified by the active SPS and the scaling lists specified by the PPS. pps_scaling_list_data_present_flag equal to 0 specifies that the scaling list data used for the pictures referring to the PPS are inferred to be equal to those specified by the active SPS. When scaling_list_enabled_flag is equal to 0, the value of pps_scaling_list_data_present_flag shall be equal to 0. When scaling_list_enabled_flag is equal to 1, sps_scaling_list_data_present_flag is equal to 0, and pps_scaling_list_data_present_flag is equal to 0, the default scaling list data are used to derive the array ScalingFactor as described in the scaling list data semantics as specified in clause 7.4.5.

deblocking_filter_override_flag equal to 1 specifies that deblocking parameters are present in the slice header. deblocking_filter_override_flag equal to 0 specifies that deblocking parameters are not present in the slice header. When not present, the value of deblocking_filter_override_flag is inferred to be equal to 0.

slice_deblocking_filter_disabled_flag equal to 1 specifies that the operation of the deblocking filter is not applied for the current slice. slice_deblocking_filter_disabled_flag equal to 0 specifies that the operation of the deblocking filter is applied for the current slice. When slice_deblocking_filter_disabled_flag is not present, it is inferred to be equal to pps_deblocking_filter_disabled_flag.

slice_beta_offset_div 2 and slice_tc_offset_div 2 specify the deblocking parameter offsets for β and tC (divided by 2) for the current slice. The values of slice_beta_offset_div 2 and slice_tc_offset_div 2 shall both be in the range of −6 to 6, inclusive. When not present, the values of slice_beta_offset_div 2 and slice_tc_offset_div 2 are inferred to be equal to pps_beta_offset_div 2 and pps_tc_offset_div 2, respectively.

slice_loop_filter_across_slices_enabled_flag equal to 1 specifies that in-loop filtering operations may be performed across the left and upper boundaries of the current slice. slice_loop_filter_across_slices_enabled_flag equal to 0 specifies that in-loop operations are not performed across left and upper boundaries of the current slice. The in-loop filtering operations include the deblocking filter and sample adaptive offset filter. When slice_loop_filter_across_slices_enabled_flag is not present, it is inferred to be equal to pps_loop_filter_across_slices_enabled_flag.

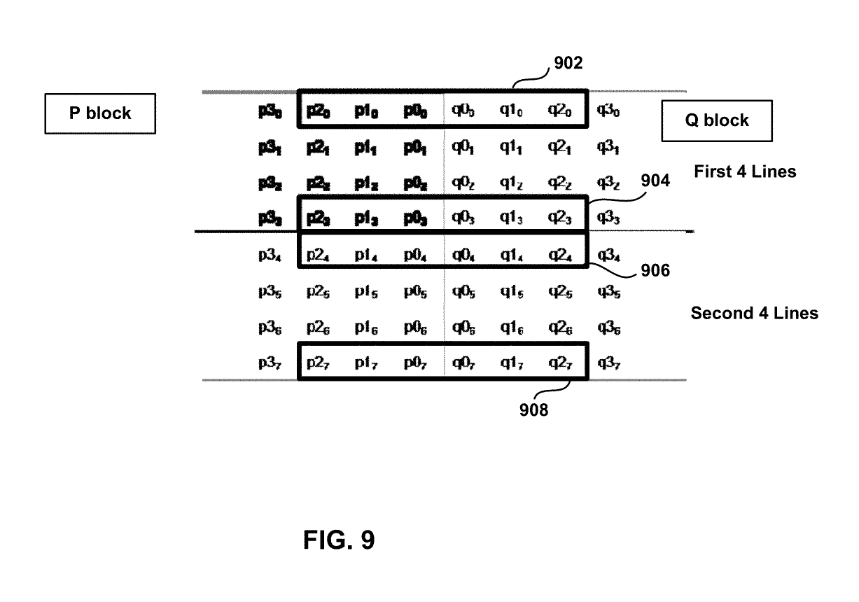

FIG. 9 shows an example of pixels involved in filter on/off decision and strong/weak filter selection. Video encoder 20 and video decoder 30 may perform a filter on/off decision for 4 lines. The filter on/off decision is made using 4 lines grouped as a unit, to reduce computational complexity. FIG. 9 illustrates the pixels involved in the decision. The 6 pixels in the two boxes (902 and 904) in the first 4 lines are used to determine whether the filter is on or off for those 4 lines. The 6 pixels in the two boxes (906 and 908) in the second group of 4 lines are used to determine whether the filter is on or off for the second group of 4 lines.

The following variables are defined:

dp0=|p_{2,0}−2*p_{1,0}+p_{0,0}|

dp3=|p_{2,3}−2*p_{1,3}+p_{0,3}|

dq0=|q_{2,0}−2*q_{1,0}+q_{0,0}|

dq3=q_{2,3}−2*q_{1,3}+q_{0,3}|

If dp0+dq0+dp3+dq3<β, filtering for the first four lines is turned on and the strong/weak filter selection process is applied. If this condition is not met, no filtering is done for the first 4 lines.

Additionally, if the condition is met, the variables dE, dEp1 and dEp2 are set as follows:

dE is set equal to 1

If dp0+dp3<(β+(β>>1))>>3, the variable dEp1 is set equal to 1

If dq0+dq3<(β+(β>>1))>>3, the variable dEq1 is set equal to 1

A filter on/off decision is made in a similar manner as described above for the second group of 4 lines.

Video encoder 20 and video decoder 30 may perform strong/weak filter selection for 4 lines. If filtering is turned on, a decision is made between strong and weak filtering. The pixels involved are the same as those used for the filter on/off decision, as depicted in FIG. 9. If the following two sets of conditions are met, a strong filter is used for filtering of the first 4 lines. Otherwise, a weak filter is used.

2*(dp0+dq0)<(β>>2),|p3₀−p0₀|+|q0₀−q3₀|<(β>>3) and |p0₀−q0₀|<(5*t_{C}+1)>>1 1)

2*(dp3+dq3)<(β>>2),|p3₃−p0₃|+|q0₃−q3₃|<(β>>3) and |p0₃−q0₃|<(5*t_{C}+1)>>1 2)

The decision on whether to select strong or weak filtering for the second group of 4 lines is made in a similar manner.

Video encoder 20 and video decoder 30 may perform strong filtering. For strong filtering, the filtered pixel values are obtained by the following equations. Note that three pixels are modified using four pixels as an input for each P and Q block, respectively.

p₀′=(p₂+2*p₁+2*p₀+2*q₀+q₁+4)>>3

q₀′=(p₁+2*p₀+2*q₀+2*q₁+q₂+4)>>3

p₁′=(p₂+p₁+p₀+q₀+2)>>2

q₁′=(p₀+q₀+q₁+q₂+2)>>2

p₂′=(2*p₃+3*p₂+p₁+p₀+q₀+4)>>3

q₂′=(p₀+q₀+q₁+3*q₂+2*q₃+4)>>3

Video encoder 20 and video decoder 30 may perform weak filtering. Δ is defined as follows.

Δ=(9*(q₀−p₀)−3*(q₁−p₁)+8)>>4

When abs(Δ) is less than t_{C}*10,

Δ=Clip3(−t_{C},t_{C},Δ)

p₀′=Clip1_{Y}(p₀+Δ)

q₀′=Clip1_{Y}(q₀−Δ)

If dEp1 is equal to 1,

Δp=Clip3(−(t_{C}>>1),t_{C}>>1,(((p₂+p₀+1)>>1)−p₁+Δ)>>1)

p₁′=Clip1_{Y}(p₁+Δp)

If dEq1 is equal to 1,

Δq=Clip3(−(t_{C}>>1),t_{C}>>1,(((q₂+q₀+1)>>1)−q₁−Δ)>>1)

q₁′=Clip1_{Y}(q₁+Δq)

Note that a maximum of two pixels are modified using three pixels as an input for each P and Q block, respectively.

Video encoder 20 and video decoder 30 may perform chroma filtering. The boundary strength Bs for chroma filtering is inherited from luma. If Bs>1, chroma filtering is performed. No filter selection process is performed for chroma, since only one filter can be applied. The filtered sample values p₀′ and q₀′ are derived as follows.

Δ=Clip3(−t_{C},t_{C},((((q₀−p₀)<<2)+p₁−q₁+4)>>3))

p₀′=Clip1_{C}(p₀+Δ)

q₀′=Clip1_{C}(q₀−Δ)

The existing ALF design has the following potential problems. As one example, an additional stage to perform ALF is required if ALF is enabled for a slice in addition to other filtering stages, such as deblocking filter. As another example problem, ALF and deblock filter (DF) may both filter same samples located at block boundaries. As another example problem, in U.S. Provisional Patent Application 62/570,036 filed 9 Oct. 2017, it is proposed to utilize the DF results for ALF classification calculation. With this method, additional gain may be achieved. Meanwhile, it still requires two stages of filters.

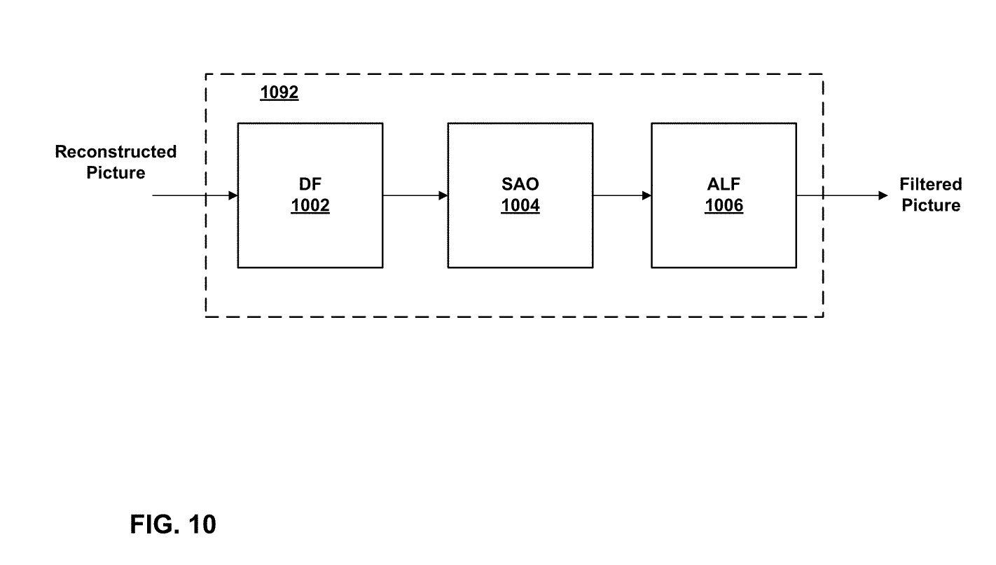

FIG. 10 shows an example of filtering stages used in JEM. In the example of FIG. 10, filter unit 1092 includes deblocking filter 1002, SAO filter 1004, and ALF 1006. Filter unit 1092 receives a reconstructed picture and filters the reconstructed picture using deblocking filter 1002, SAO filter 1004, and ALF 1006 to produce a filtered picture that can either be displayed or stored in a decoded picture buffer.

This disclosure describes techniques for unifying the DF and ALF process such that only one filtering process may be applied. In other words, ALF may be applied without waiting for the output of DF.

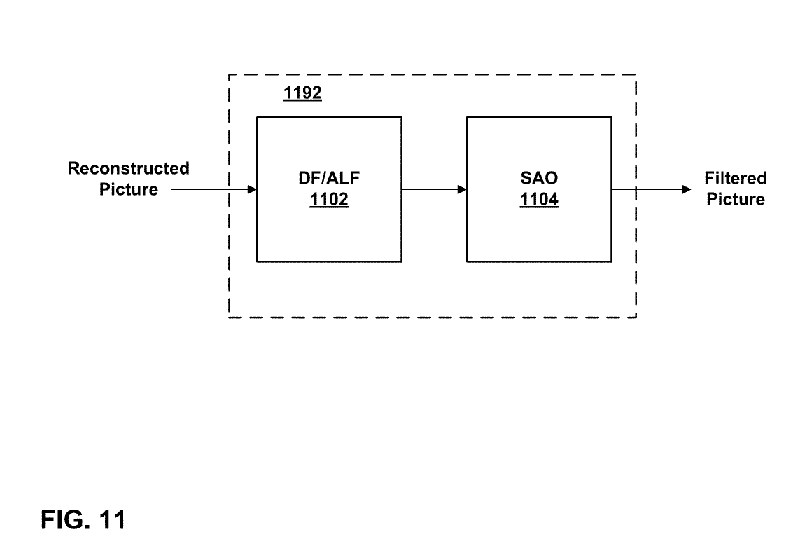

FIG. 11 shows an example of filtering stages after reconstruction in accordance with the techniques of this disclosure. In the example of FIG. 11, filter unit 1192 includes combined deblocking filter/ALF 1102 and SAO filter 1104. Filter unit 1192 receives a reconstructed picture and filters the reconstructed picture using combined deblocking filter/ALF 1102 and SAO filter 1104 to produce a filtered picture that can either be displayed or stored in a decoded picture buffer.

The following techniques may be applied individually. Alternatively, any combination of the techniques may be applied. Alternatively, furthermore, DF and/or ALF may be replaced by other filtering methods.

In some examples, a DF process may still be applied to samples at a block boundary involved in prior DF process while ALF process may be applied to other remaining samples. In one example, the existing rules for DF filter selection and ALF filter decision processes are kept unchanged. In another example, the rule for DF and ALF filter selection may be unified. However, the filters may be associated with different supports, and/or different filter types (such as strong and weak filter, linear and non-linear filter, wiener filter and others). In another example, the filters for ALF and DF may be associated with same supports, and/or same filter types (such as strong or weak filter, linear or non-linear filter, wiener filters). However, the rule for DF and ALF filter selection may be different.

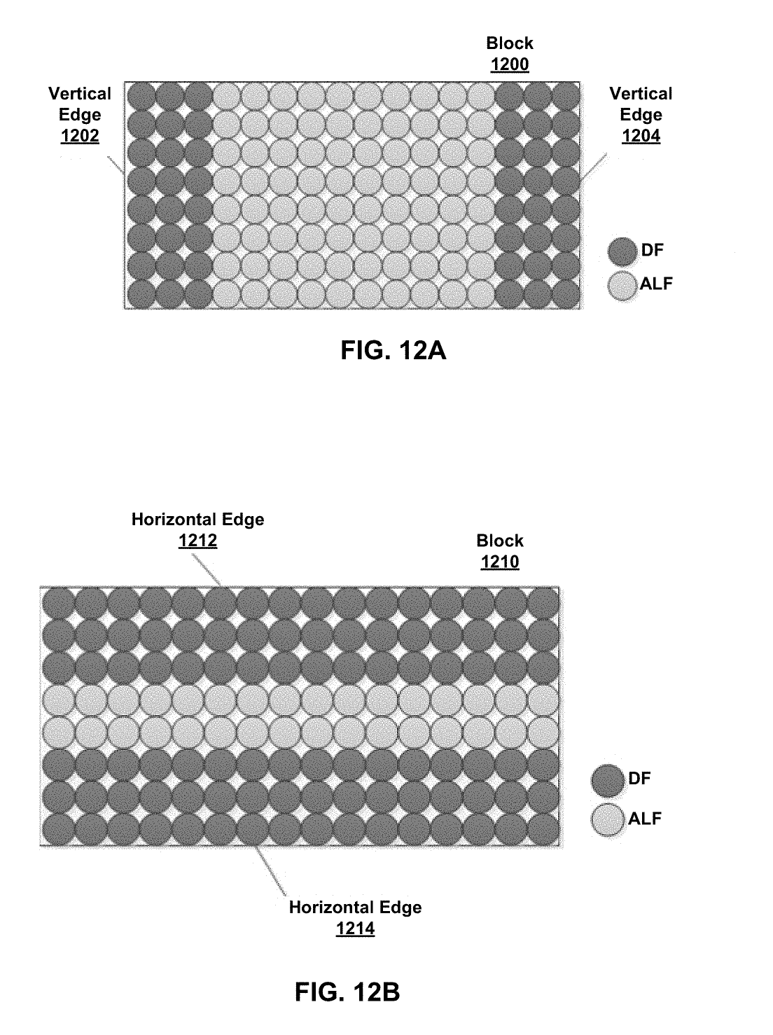

FIGS. 12A and 12B show examples of relative positions of samples which may be filtered by DF and ALF. FIG. 12A shows, for the first stage, samples of block 1200 that may be filtered by DF and ALF. In FIG. 12A, samples more than three columns away from vertical edge 1202 and more than three columns away from vertical edge 1204 are filtered using ALF, while samples that are within three columns of vertical edge 1202 or within three columns of vertical edge 1204 are deblock filtered. FIG. 12B shows, for the second stage, samples of block 1210 which may be filtered by DF and ALF. In FIG. 12B, samples more than three rows away from horizontal edge 1212 and more than three rows away from horizontal edge 1214 are filtered using ALF, while samples that are within three rows of horizontal edge 1212 or within three rows of horizontal edge 1214 are deblock filtered.

In some examples, the two-stage DF process (including filtering vertical edges and horizontal edges) may still apply and ALF may be invoked for each of the DF stage. An example of the unified solution is depicted as follows. In some examples, the first stage DF and ALF may be performed in parallel with the same input, that is, the reconstructed picture. While the second stage DF and ALF may be performed in parallel with the output of the first stage DF and ALF.

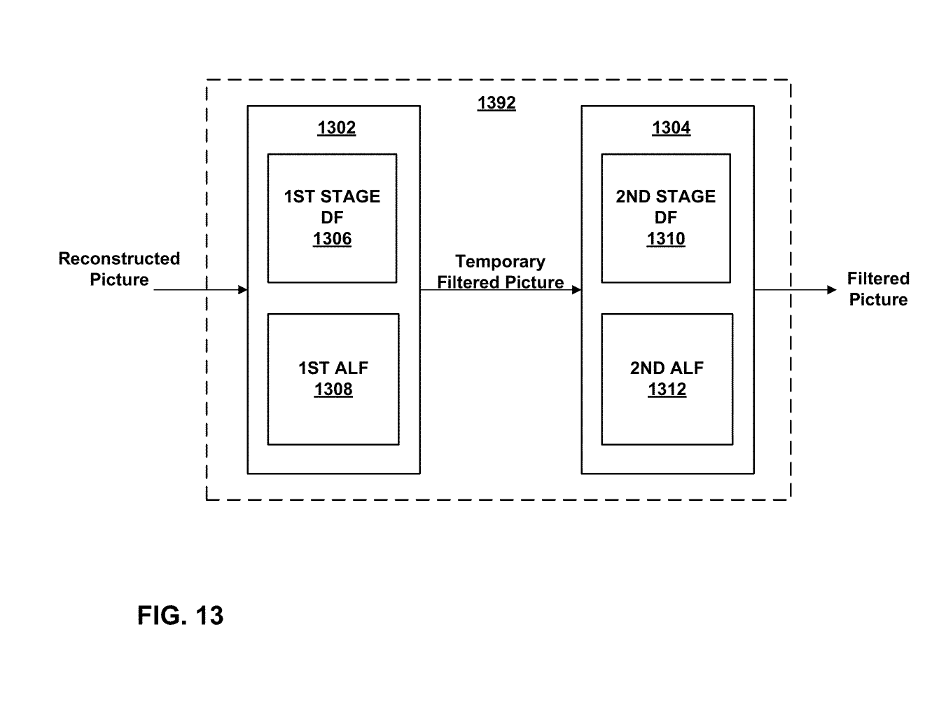

FIG. 13 shows filter unit 1392, which is configured to perform DF and ALF in parallel in two stages. Filter unit 1392 includes first stage filter 1302 and second stage filter 1304. First stage filter 1302 includes first stage DF 1306 and first ALF 1308, which may be configured to filter samples of a reconstructed picture in parallel to produce a temporary filtered picture. Second stage filter 1304 includes second stage DF 1310 and second ALF 1312, which may be configured to filter samples of temporary filtered picture in parallel to produce a filtered picture that may be either displayed, stored in a decoded picture buffer, or output for SAO filtering or other processing. In the example of FIG. 13, samples filtered by first-stage ALF 1308 may not depend on samples changed in by first-stage DF 1306, samples filtered by first-stage DF 1306 may not depend on samples changed by the first-stage ALF 1308. Samples filtered by second-stage ALF 1312 may not depend on samples changed by second-stage DF 1310, and samples filtered by second-stage DF 1310 may not depend on samples changed by second-stage ALF 1312.

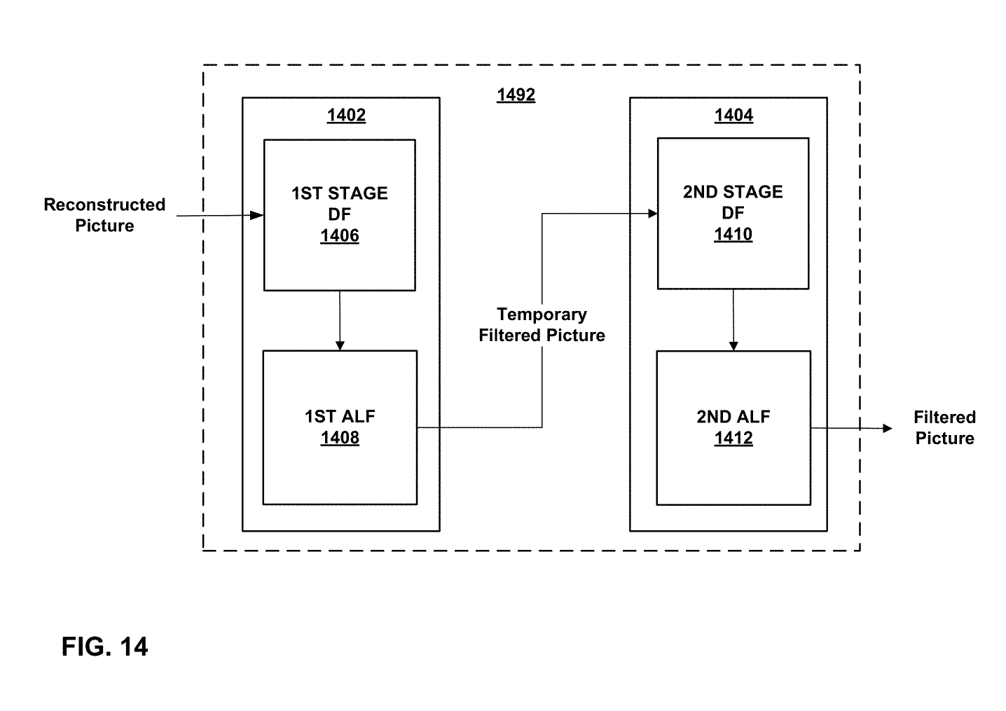

FIG. 14 depicts another example of a unified solution. FIG. 14 shows filter unit 1492, which is configured to perform DF and ALF in two stages. Filter unit 1492 includes first stage filter 1402 and second stage filter 1404. First stage filter 1402 includes first stage DF 1406 and first ALF 1408, which may be configured to filter samples of a reconstructed picture to produce a temporary filtered picture. Second stage filter 1404 includes second stage DF 1410 and second ALF 1412, which may be configured to filter samples of the temporary filtered picture to produce a filtered picture that may be displayed, stored in a decoded picture buffer, or output for other processing, such as SAO filtering. In the example of FIG. 14, for each stage, ALF is performed after DF which means the samples filtered by DF are utilized in ALF. In one example, ALF may be performed twice as mentioned above and filter information (such as on/off, filter coefficients, filter merging information) may be signaled for each of the two stages.

In one example, ALF may be performed twice as mentioned above and filter coefficients for the second stage may be predicted from those utilized in the first stage. In some examples, ALF may be performed only together with the last stage.

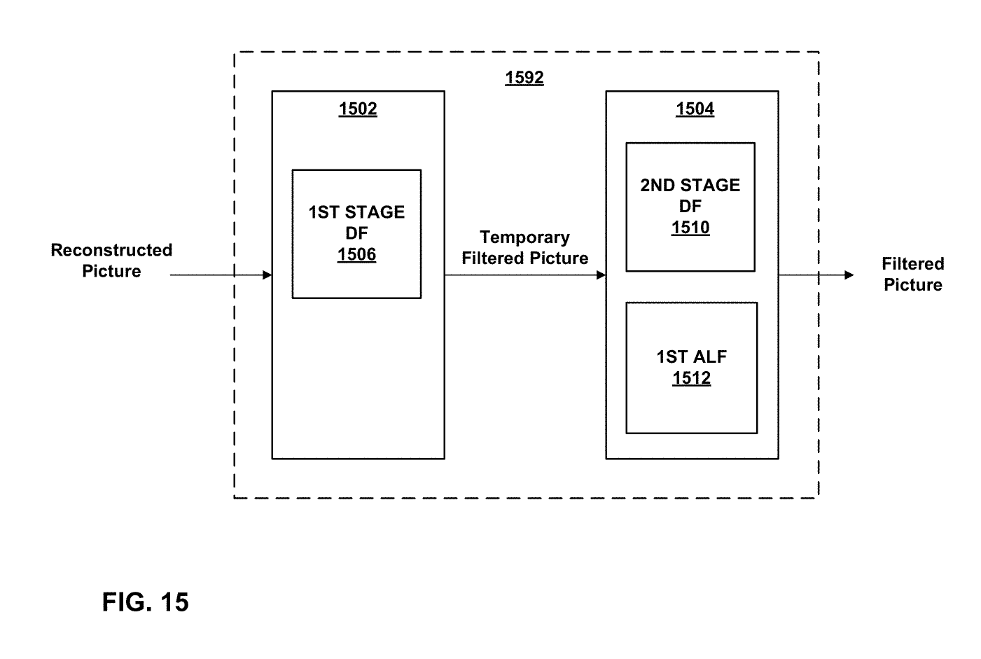

FIG. 15 shows an example of a unified DB and ALF solution with a parallel second stage. FIG. 15 shows filter unit 1592, which is configured to perform DF and ALF in two stages. Filter unit 1592 includes first stage filter 1502 and second stage filter 1504. First stage filter 1502 includes first stage DF 1506, which may be configured to filter samples of a reconstructed picture to produce a temporary filtered picture. Second stage filter 1504 includes second stage DF 1510 and second ALF 1512, which may be configured to filter samples of the temporary filtered picture to produce a filtered picture that may be either displayed or stored in a decoded picture buffer. In the example of FIG. 15, for second stage filter 1504, samples filtered by second-stage ALF 1512 may not depend on samples changed by second-stage DF 1510, and samples filtered by second-stage DF 1510 may not depend on samples changed by second-stage ALF 1512.

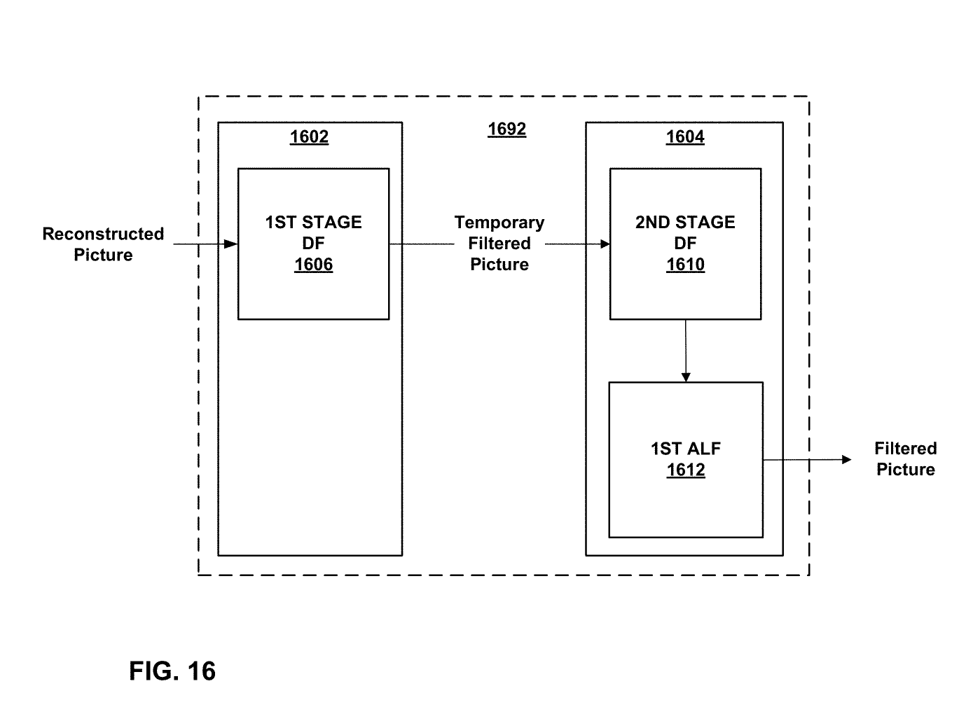

FIG. 16 shows an example of a unified DB and ALF solution with a sequential second stage. FIG. 16 shows filter unit 1692, which is configured to perform DF and ALF in two stages. Filter unit 1692 includes first stage filter 1602 and second stage filter 1604. First stage filter 1602 includes first stage DF 1606, which may be configured to filter samples of a reconstructed picture to produce a temporary filtered picture. Second stage filter 1604 includes second stage DF 1610 and ALF 1612, which may be configured to filter samples of the temporary filtered picture to produce a filtered picture that may be displayed, stored in a decoded picture buffer, or output for other processing, such as SAO filtering. For second stage filter 1604, ALF is performed after DF which means the samples filtered by DF are utilized in ALF.

According to some examples of this disclosure, the filtering techniques or filtering coefficients of ALF may be different for samples which are closer to block boundaries and which are further from block boundaries. Here, a sample which not modified by DF may be also treated as ‘close to block boundaries’. A threshold or multiple thresholds may be defined or signaled to indicate how many samples from a block boundary is treated as ‘closer to block boundary’. The filtering methods or filtering coefficients of ALF may be different for samples at different boundaries, such as the vertical boundaries or the horizontal boundaries.

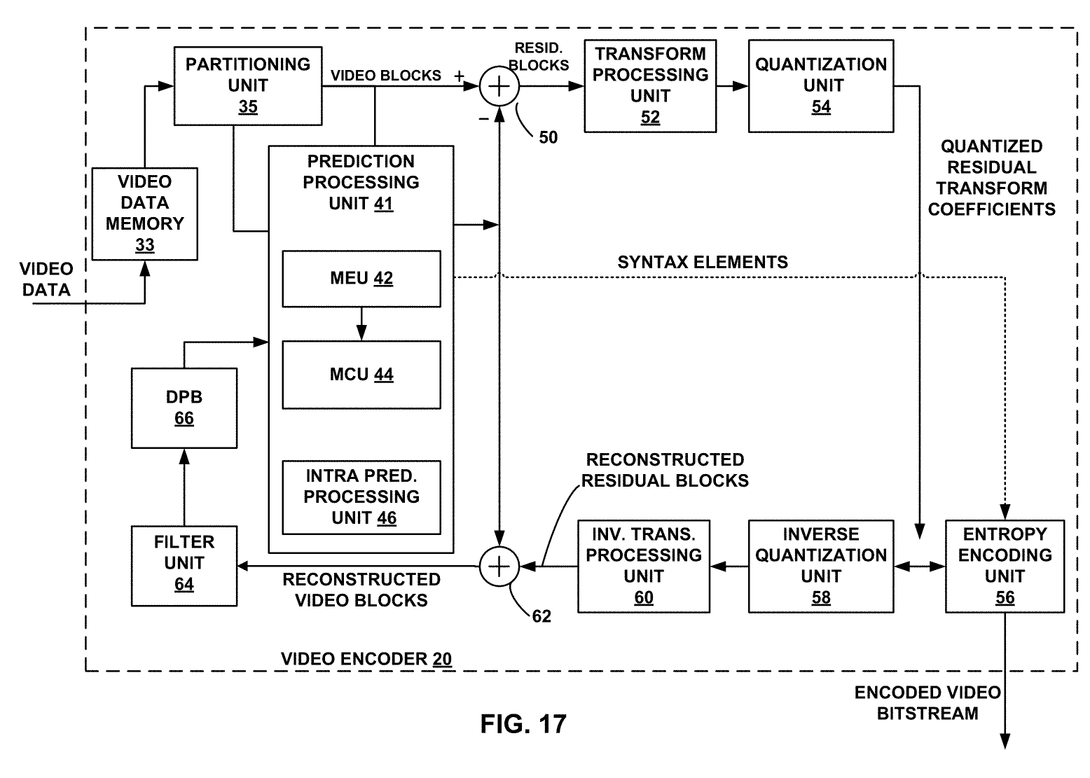

FIG. 17 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 17, video encoder 20 includes a video data memory 33, partitioning unit 35, prediction processing unit 41, summer 50, transform processing unit 52, quantization unit 54, entropy encoding unit 56. Prediction processing unit 41 includes motion estimation unit (MEU) 42, motion compensation unit (MCU) 44, and intra prediction unit 46. For video block reconstruction, video encoder 20 also includes inverse quantization unit 58, inverse transform processing unit 60, summer 62, filter unit 64, and decoded picture buffer (DPB) 66.

As shown in FIG. 17, video encoder 20 receives video data and stores the received video data in video data memory 33. Video data memory 33 may store video data to be encoded by the components of video encoder 20. The video data stored in video data memory 33 may be obtained, for example, from video source 18. DPB 66 may be a reference picture memory that stores reference video data for use in encoding video data by video encoder 20, e.g., in intra- or inter-coding modes. Video data memory 33 and DPB 66 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 33 and DPB 66 may be provided by the same memory device or separate memory devices. In various examples, video data memory 33 may be on-chip with other components of video encoder 20, or off-chip relative to those components.

Partitioning unit 35 retrieves the video data from video data memory 33 and partitions the video data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 66. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in DPB 66. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

After prediction processing unit 41 generates the predictive block for the current video block, either via intra prediction or inter prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed block.

Filter unit 64 filters the reconstructed block (e.g. the output of summer 62) and stores the filtered reconstructed block in DPB 66 for uses as a reference block. The reference block may be used by motion estimation unit 42 and motion compensation unit 44 as a reference block to inter-predict a block in a subsequent video frame or picture. Filter unit 64 may perform additional types of filtering such as deblock filtering, sample adaptive offset (SAO) filtering, or other types of loop filters. A deblock filter may, for example, apply deblocking filtering to filter block boundaries to remove blockiness artifacts from reconstructed video. An SAO filter may apply offsets to reconstructed pixel values in order to improve overall coding quality. Additional loop filters (in loop or post loop) may also be used.

Filter unit 64 may also apply filtering to video blocks by determining, for an individual pixel, or for a sub-block (e.g., a 2×2, 4×4, or some other size sub-block), of the video block, values for one or more metrics, and based on the one or more metrics, determine a class for the pixel or sub-block. Filter unit 64 may, for example, determine the values for the metrics and the class using the techniques described above. Filter unit 64 may then filter the pixel or sub-block using the filter, from the set of filters, mapped to the determined class.

Filter unit 64 in conjunction with other components may be configured to perform various techniques described in this disclosure. Filter unit 64 may, for example, perform deblocking filtering and ALF according to the techniques described above. In this regard, any of filter units 1092, 1192, 1392, 1492, 1592, or 1692 may be implemented as filter unit 64 or as a component of filter unit 64.

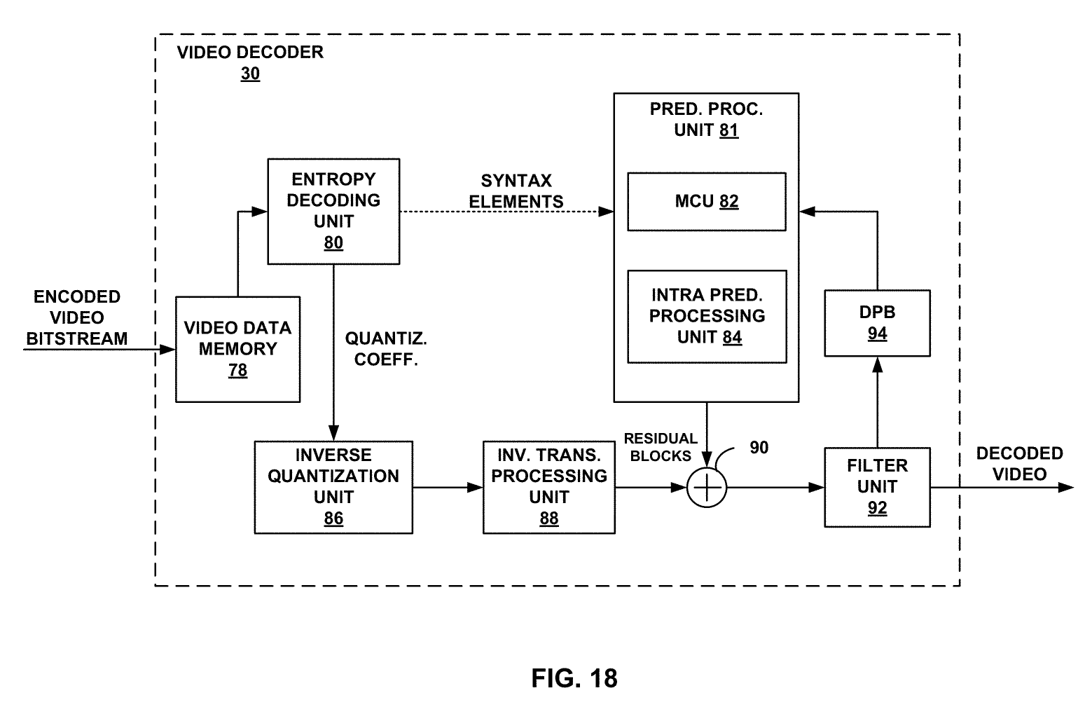

FIG. 18 is a block diagram illustrating an example video decoder 30 that may implement the techniques described in this disclosure. Video decoder 30 of FIG. 18 may, for example, be configured to receive the signaling described above with respect to video encoder 20 of FIG. 17. In the example of FIG. 18, video decoder 30 includes video data memory 78, entropy decoding unit 80, prediction processing unit 81, inverse quantization unit 86, inverse transform processing unit 88, summer 90, and DPB 94. Prediction processing unit 81 includes motion compensation unit 82 and intra prediction unit 84. Video decoder 30 may, in some examples, perform a decoding pass generally reciprocal to the encoding pass described with respect to video encoder 20 from FIG. 17.

During the decoding process, video decoder 30 receives an encoded video bitstream that represents video blocks of an encoded video slice and associated syntax elements from video encoder 20. Video decoder 30 stores the received encoded video bitstream in video data memory 78. Video data memory 78 may store video data, such as an encoded video bitstream, to be decoded by the components of video decoder 30. The video data stored in video data memory 78 may be obtained, for example, via link 16, from storage device 26, or from a local video source, such as a camera, or by accessing physical data storage media. Video data memory 78 may form a coded picture buffer (CPB) that stores encoded video data from an encoded video bitstream. DPB 94 may be a reference picture memory that stores reference video data for use in decoding video data by video decoder 30, e.g., in intra- or inter-coding modes. Video data memory 78 and DPB 94 may be formed by any of a variety of memory devices, such as DRAM, SDRAM, MRAM, RRAM, or other types of memory devices. Video data memory 78 and DPB 94 may be provided by the same memory device or separate memory devices. In various examples, video data memory 78 may be on-chip with other components of video decoder 30, or off-chip relative to those components.

Entropy decoding unit 80 of video decoder 30 entropy decodes the video data stored in video data memory 78 to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction unit 84 of prediction processing unit 81 may generate prediction data for a video block of the current video slice based on a signaled intra prediction mode and data from previously decoded blocks of the current frame or picture. When the video frame is coded as an inter-coded slice (e.g., B slice or P slice), motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in DPB 94.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After prediction processing unit generates the predictive block for the current video block using, for example, intra or inter prediction, video decoder 30 forms a reconstructed video block by summing the residual blocks from inverse transform processing unit 88 with the corresponding predictive blocks generated by motion compensation unit 82. Summer 90 represents the component or components that perform this summation operation. Filter unit 92 filters the reconstructed video block using, for example, one or more of the ALF techniques described in this disclosure.

Filter unit 92 may, for example, filter a video block by determining, for an individual pixel, or for a sub-block (e.g., a 2×2, 4×4, or some other size sub-block), of the video block, values for one or more metrics, and based on the one or more metrics, determine a class for the pixel or sub-block. Filter unit 92 may, for example, determine the values for the metrics and the class using techniques described above. Filter unit 92 may then filter the pixel or sub-block using the filter, from the set of filters, mapped to the determined class.

Filter unit 92 may additionally perform one or more of deblocking filter, SAO filtering, or other types of filtering. Other loop filters (either in the coding loop or after the coding loop) may also be used to smooth pixel transitions or otherwise improve the video quality.

Filter unit 92 in conjunction with other components, such as entropy decoding unit 80 of video decoder 30 may be configured to perform the various techniques described in this disclosure. Filter unit 92 may, for example, perform deblocking filtering and ALF according to the techniques described above. In this regard, any of filter units 1092, 1192, 1392, 1492, 1592, or 1692 may be implemented as filter unit 92 or as a component of filter unit 92.

The decoded video blocks in a given frame or picture are then stored in DPB 94, which stores reference pictures used for subsequent motion compensation. DPB 94 may be part of or separate from additional memory that stores decoded video for later presentation on a display device, such as display device 32 of FIG. 1.

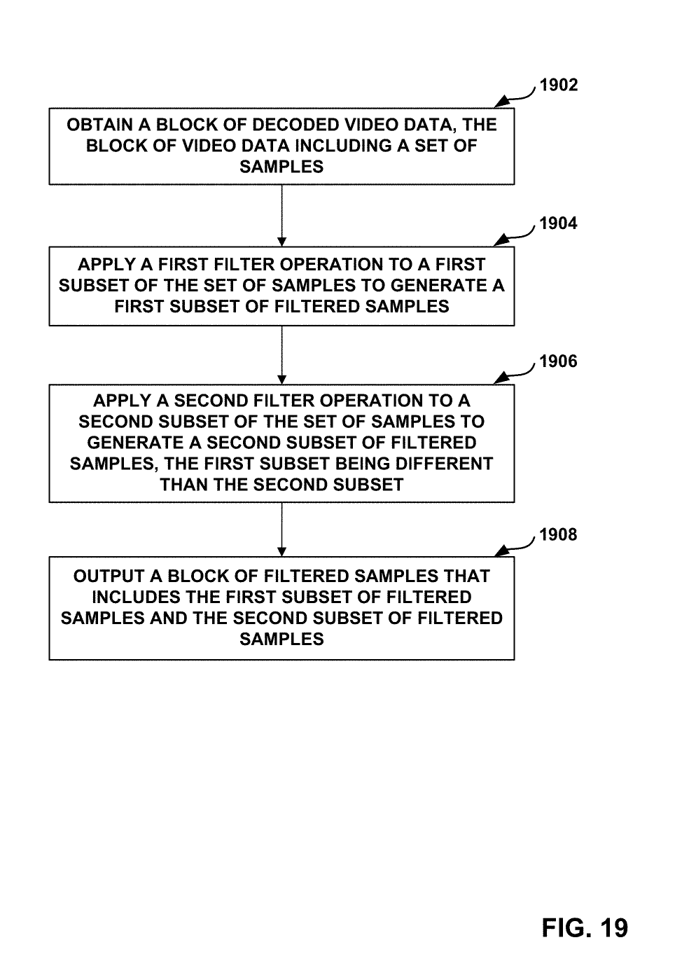

FIG. 19 is a flow diagram illustrating an example video decoding technique described in this disclosure. The techniques of FIG. 19 will be described with reference to a generic video decoder, such as but not limited to video decoder 30. In some instances, the techniques of FIG. 19 may be performed by a video encoder such as video encoder 20, as part of a video encoding process, in which case the generic video decoder corresponds to the decoding loop (e.g., inverse quantization unit 58, inverse transform processing unit 60, summer 62, and filter unit 64) of video encoder 20.

In the example of FIG. 19, the video decoder obtains a block of decoded video data, the block of video data including a set of samples (1902). The block of video data may, for example, be a reconstructed block of video data that represents the sum of a predicted block and a residual block.

The video decoder applies a first filter operation to a first subset of the set of samples to generate a first subset of filtered samples (1904). The video decoder applies a second filter operation to a second subset of the set of samples to generate a second subset of filtered samples, with the first subset being different than the second subset (1906). The video decoder may, for example, receive a syntax element in the video data, and based on the syntax element, determine whether samples from the set of samples belong to the first subset or the second subset. In other examples, the video decoder may determine whether samples from the set of samples belong to the first subset or the second subset without explicit signaling, using, for example, a predetermined selection technique.

In some examples, when applying the first filter operation to the first subset of the set of samples, the video decoder may not utilize samples altered by the second filter operation, and when applying the second filter operation to the second subset of the set of samples, the video decoder does not utilize samples altered by the first filter operation. In some examples, the first filter operation may be a deblock filtering operation, and the second filter operation may be an ALF operation.

In other examples, the first filter operation may be a first ALF operation and the second filter operation may be a second ALF operation. The first adaptive loop filtering operation may apply a first filter with a first set of filter coefficients, and the second adaptive loop filtering operation may apply a second filter with a second set of filter coefficients, with the first set of filter coefficients being different than the second set of filter coefficients.

The video decoder outputs a block of filtered samples that includes the first subset of filtered samples and the second subset of filtered samples (1908). The video decoder may, for example, output the block of filtered samples as part of a picture to be displayed or as part of a picture to be stored in a decoded picture buffer. In some examples, the video decoder may output the block of filtered samples for further filtering or further processing.

In one example, if the video decoder outputs the block of filtered samples for further filtering, then the video decoder may apply a third filter operation to a first subset of samples of the temporary block to generate a third subset of filtered samples, apply a fourth filter operation to a second subset of samples of the temporary block to generate a fourth subset of filtered samples, and output a second block of filtered samples comprising the third subset of filtered samples and the fourth subset of filtered samples.

In some examples, the block may include a first vertical boundary and a second vertical boundary. The first subset of samples may include samples within a threshold number of samples away from one of the first vertical boundary or the second vertical boundary, and the second subset of samples may include samples more than a threshold number of samples away from the first vertical boundary and the second vertical boundary. In some examples, the block may include a first horizontal boundary and a second horizontal boundary. The first subset of samples may include samples within a threshold number of samples away from one of the first horizontal boundary or the second horizontal boundary, and the second subset of samples may include samples more than a threshold number of samples away from the first horizontal boundary and the second horizontal boundary.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising;
obtaining a block of reconstructed video data, wherein the block of video data comprises a set of samples;
applying a first filter operation to a first subset of the set of samples to generate a first subset of filtered samples;
applying a second filter operation to a second subset of the set of samples to generate a second subset of filtered samples, wherein the first subset is different than the second subset; and
outputting a block of filtered samples comprising the first subset of filtered samples and the second subset of filtered samples.

2. The method of claim 1, wherein
applying the first filter operation to the first subset of the set of samples does not utilize the second subset of the set of samples or the second subset of filtered samples, and wherein applying the second filter operation to the second subset of the set of samples does not utilize the first subset of the set of samples or the first subset of filtered samples.

3. The method of claim 1, wherein the first filter operation comprises a deblock filtering operation and the second filter operation comprises an adaptive loop filter operation.

4. The method of claim 1, wherein the first filter operation comprises a first adaptive loop filtering operation and the second filter operation comprises a second adaptive loop filter operation.

5. The method of claim 4, wherein the first adaptive loop filtering operation applies a first filter with a first set of filter coefficients and the second adaptive loop filtering operation applies a second filter with a second set of filter coefficients, wherein the first set of filter coefficients are different than the second set of filter coefficients.

6. The method of claim 1, further comprising:
receiving a syntax element in the video data;
based on the syntax element, determining which samples from the set of samples belong to the first subset and which samples from the set of samples belong to the second subset.

7. The method of claim 1, wherein the block comprises a first vertical boundary and a second vertical boundary, the first subset of samples comprises samples within a threshold number of samples away from one of the first vertical boundary or the second vertical boundary and the second subset of samples comprises samples more than the threshold number of samples away from the first vertical boundary and the second vertical boundary.

8. The method of claim 1, wherein the block comprises a first horizontal boundary and a second horizontal boundary, the first subset of samples comprises samples within a threshold number of samples away from one of the first horizontal boundary or the second horizontal boundary and the second subset of samples comprises samples more than the threshold number of samples away from the first horizontal boundary and the second horizontal boundary.

9. The method of claim 1, wherein the block of filtered samples comprises a temporary block, the method further comprising:
applying a third filter operation to a first subset of samples of the temporary block to generate a third subset of filtered samples;
applying a fourth filter operation to a second subset of samples of the temporary block to generate a fourth subset of filtered samples wherein the third subset is different than the fourth subset;
outputting a second block of filtered samples comprising the third subset of filtered samples and the fourth subset of filtered samples.

10. The method of claim 1, wherein the method of decoding is performed as part of a video encoding process.

11. A device for decoding video data, the device comprising:
a memory configured to store video data; and
one or more processors coupled to the memory, implemented in circuitry, and configured to:
obtain a block of reconstructed video data, wherein the block of video data comprises a set of samples;
apply a first filter operation to a first subset of the set of samples to generate a first subset of filtered samples;
apply a second filter operation to a second subset of the set of samples to generate a second subset of filtered samples, wherein the first subset is different than the second subset; and
output a block of filtered samples comprising the first subset of filtered samples and the second subset of filtered samples.

12. The device of claim 11, wherein
applying the first filter operation to the first subset of the set of samples does not utilize the second subset of the set of samples or the second subset of filtered samples, and wherein applying the second filter operation to the second subset of the set of samples does not utilize the first subset of the set of samples or the first subset of filtered samples.

13. The device of claim 11, wherein the first filter operation comprises a deblock filtering operation and the second filter operation comprises an adaptive loop filter operation.

14. The device of claim 11, wherein the first filter operation comprises a first adaptive loop filtering operation and the second filter operation comprises a second adaptive loop filter operation.

15. The device of claim 14, wherein the first adaptive loop filtering operation applies a first filter with a first set of filter coefficients and the second adaptive loop filtering operation applies a second filter with a second set of filter coefficients, wherein the first set of filter coefficients are different than the second set of filter coefficients.

16. The device of claim 11, wherein the one or more processors are further configured to:
receive a syntax element in the video data; and
based on the syntax element, determine which samples from the set of samples belong to the first subset and which samples from the set of samples belong to the second subset.

17. The device of claim 11, wherein the block comprises a first vertical boundary and a second vertical boundary, the first subset of samples comprises samples within a threshold number of samples away from one of the first vertical boundary or the second vertical boundary and the second subset of samples comprises samples more than the threshold number of samples away from the first vertical boundary and the second vertical boundary.

18. The device of claim 11, wherein the block comprises a first horizontal boundary and a second horizontal boundary, the first subset of samples comprises samples within a threshold number of samples away from one of the first horizontal boundary or the second horizontal boundary and the second subset of samples comprises samples more than the threshold number of samples away from the first horizontal boundary and the second horizontal boundary.

19. The device of claim 11, wherein the block of filtered samples comprises a temporary block, and the one or more processors are further configured to:
apply a third filter operation to a first subset of samples of the temporary block to generate a third subset of filtered samples;
apply a fourth filter operation to a second subset of samples of the temporary block to generate a fourth subset of filtered samples wherein the third subset is different than the fourth subset; and
output a second block of filtered samples comprising the third subset of filtered samples and the fourth subset of filtered samples.

20. The device of claim 11, wherein the device comprises a wireless communication device, further comprising a receiver configured to receive and demodulate a signal comprising the encoded video data.

21. The device of claim 20, wherein the wireless communication device comprises a display configured to display decoded video data.

22. The device of claim 11, wherein the device comprises a wireless communication device, further comprising a transmitter configured to transmit encoded video data.

23. The device of claim 22, wherein the wireless communication device comprises a telephone handset and wherein the transmitter is configured to modulate, according to a wireless communication standard, a signal comprising the encoded video data.

24. A computer-readable storage medium storing instructions that when executed by one or more processors cause the one or more processors to:
obtain a block of reconstructed video data, wherein the block of video data comprises a set of samples;
apply a first filter operation to a first subset of the set of samples to generate a first subset of filtered samples;
apply a second filter operation to a second subset of the set of samples to generate a second subset of filtered samples, wherein the first subset is different than the second subset; and
output a block of filtered samples comprising the first subset of filtered samples and the second subset of filtered samples.

25. The computer-readable storage medium of claim 24, wherein the first filter operation comprises a deblock filtering operation and the second filter operation comprises an adaptive loop filter operation.

26. The computer-readable storage medium of claim 24, wherein the block comprises a first vertical boundary and a second vertical boundary, the first subset of samples comprises samples within a threshold number of samples away from one of the first vertical boundary or the second vertical boundary and the second subset of samples comprises samples more than the threshold number of samples away from the first vertical boundary and the second vertical boundary.

27. The computer-readable storage medium of claim 24, wherein the block comprises a first horizontal boundary and a second horizontal boundary, the first subset of samples comprises samples within a threshold number of samples away from one of the first horizontal boundary or the second horizontal boundary and the second subset of samples comprises samples more than the threshold number of samples away from the first horizontal boundary and the second horizontal boundary.

28. An apparatus comprising:
means for obtaining a block of reconstructed video data, wherein the block of video data comprises a set of samples;
means for applying a first filter operation to a first subset of the set of samples to generate a first subset of filtered samples;
means for applying a second filter operation to a second subset of the set of samples to generate a second subset of filtered samples, wherein the first subset is different than the second subset; and
means for outputting a block of filtered samples comprising the first subset of filtered samples and the second subset of filtered samples.

29. The apparatus of claim 28, wherein the block comprises a first vertical boundary and a second vertical boundary, the first subset of samples comprises samples within a threshold number of samples away from one of the first vertical boundary or the second vertical boundary and the second subset of samples comprises samples more than the threshold number of samples away from the first vertical boundary and the second vertical boundary.

30. The apparatus of claim 28, wherein the block comprises a first horizontal boundary and a second horizontal boundary, the first subset of samples comprises samples within a threshold number of samples away from one of the first horizontal boundary or the second horizontal boundary and the second subset of samples comprises samples more than the threshold number of samples away from the first horizontal boundary and the second horizontal boundary.
